(19) United States
(12) Patent Application Publication
(10) Pub. No.: US 2009/0328109 A1
(43) Pub. Date: Dec. 31, 2009

(54) Providing Television Broadcasts over a Managed Network and Interactive Content over an Unmanaged Network to a Client Device

(75) Inventors: Lena Y. Pavlovskaia, Cupertino, CA (US); Andreas Lennartsson, Manchester, MD (US); Charles Lawrence, Fremont, CA (US); Joshua Dahlby, Scotts Valley, CA (US); Andrey Marsavin, San Jose, CA (US); Gregory E. Brown, Fremont, CA (US); Jeremy Edmonds, Campbell, CA (US); Hsuehmin Li, Milpitas, CA (US); Vlad Shamgin, Sacramento, CA (US)

Correspondence Address: Sunstein Kann Murphy & Timbers LLP, 125 SUMMER STREET, BOSTON, MA, 02110-1618, US

(73) Assignee: ACTIVEVIDEO NETWORKS, INC., San Jose, CA (US)

(21) Appl. No.: 12/489,017

(22) Filed: Jun. 22, 2009

Related U.S. Application Data
(63) Continuation-in-part of application No. 12/008,697, filed on Jan. 11, 2008.
Application No. 12/008,697 is a continuation-in-part of application No. 12/008,722, filed on Jan. 11, 2008.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.
(60) Provisional application No. 60/884,773, filed on Jan. 12, 2007.
(60) Provisional application No. 60/884,744, filed on Jan. 12, 2007.
(60) Provisional application No. 60/884,772, filed on Jan. 12, 2007.
(60) Provisional application No. 61/133,102, filed on Jun. 25, 2008.

(51) Int. Cl. H04N 7/173; H04N 7/20

(52) U.S. Cl. 725/70; 725/110

(57) ABSTRACT

A client device receives a broadcast content signal containing an interactive identifier over a managed network at a client device. The interactive identifier may be a trigger that is included in a header or embedded within the digital video data. The trigger may have a temporal component, wherein the trigger can expire after a certain period of time. In response to identification of the trigger, the client device sends a user request for interactive content over an unmanaged network. For example, the managed network may be a one-way satellite television network, IP-television network or cable television network and the unmanaged network may be the Internet. The client device switches between receiving data from the managed network to receiving data from the unmanaged network.

### PRIORITY

The present U.S. patent application is a continuation-in-part of U.S. patent application Ser. No. 12/008,697 filed Jan. 11, 2008 entitled “Interactive Encoded Content System including Object Models for Viewing on a Remote Device” which itself claims priority from U.S. provisional applications Ser. No. 60/884,773, filed Jan. 12, 2007, Ser. No 60/884,744, filed Jan. 12, 2007, and Ser. No. 60/884,772, filed Jan. 12, 2007, the full disclosures of which are all hereby incorporated herein by reference.

The present U.S. patent application is a continuation-in-part of U.S. patent application Ser. No. 12/008,722 filed on Jan. 11, 2008 entitled “MPEG Objects and Systems and Methods for Using MPEG Objects”, which itself claims priority from U.S. provisional applications Ser. No. 60/884,773, filed Jan. 12, 2007, Ser. No 60/884,744, filed Jan. 12, 2007, and Ser. No. 60/884,772, filed Jan. 12, 2007, the full disclosures of which are all hereby incorporated herein by reference.

The present. U.S. patent application also claims priority from U.S. provisional patent application No. 61/133,102 filed on Jun. 25, 2008 having the title “Providing Television Broadcasts over a Managed Network and Interactive Content over an Unmanaged Network to a Client Device”, which is incorporated by reference herein in its entirety.

### TECHNICAL FIELD AND BACKGROUND ART

The present invention relates to systems and methods for providing interactive content to a remote device and more specifically to systems and methods employing both a managed and an unmanaged network.

In cable television systems, the cable head-end transmits content to one or more subscribers wherein the content is transmitted in an encoded form. Typically, the content is encoded as digital MPEG video and each subscriber has a set-top box or cable card that is capable of decoding the MPEG video stream. Beyond providing linear content, cable providers can now provide interactive content, such as web pages or walled-garden content. As the Internet has become more dynamic, including video content on web pages and requiring applications or scripts for decoding the video content, cable providers have adapted to allow subscribers the ability to view these dynamic web pages. In order to transmit a dynamic web page to a requesting subscriber in encoded form, the cable head end retrieves the requested web page and renders the web page. Thus, the cable headend must first decode any encoded content that appears within the dynamic webpage. For example, if a video is to be played on the webpage, the headend must retrieve the encoded video and decode each frame of the video. The cable headend then renders each frame to form a sequence of bitmap images of the Internet web page. Thus, the web page can only be composited together if all of the content that forms the web page is first decoded. Once the composite frames are complete, the composited video is sent to an encoder, such as an MPEG encoder to be re-encoded. The compressed MPEG video frames are then sent in an MPEG video stream to the user's set-top box.

Creating such composite encoded video frames in a cable television network requires intensive CPU and memory processing, since all encoded content must first be decoded, then composited, rendered, and re-encoded. In particular, the cable headend must decode and re-encode all of the content in real-time. Thus, allowing users to operate in an interactive environment with dynamic web pages is quite costly to cable operators because of the required processing. Additionally, such systems have the additional drawback that the image quality is degraded due to re-encoding of the encoded video.

Satellite television systems suffer from the problem that they are limited to one-way transmissions. Thus, satellite television providers can not offer “on-demand” or interactive services. As a result, satellite television networks are limited to providing a managed network for their subscribers and can not provide user requested access to interactive information. Other communication systems cannot provide interactive content, for example, cable subscribers that have one-way cable cards or cable systems that do not support two-way communications.

### SUMMARY OF THE INVENTION

In a first embodiment of the invention, interactive content is provided to a user's display device over an unmanaged network. A client device receives a broadcast content signal containing an interactive identifier over a managed network at a client device. The interactive identifier may be a trigger that is included in a header or embedded within the digital video data. The trigger may have a temporal component depending on the trigger's temporal location within the data stream or a designated frame or time for activation. Additionally, the triggers may have an expiration wherein the trigger can expire after a certain period of time. In response to identification of the trigger, the client device sends a request for interactive content over an unmanaged network. For example, the managed network may be a one-way satellite television network, IP-television network or a broadcast cable television network and the unmanaged network may be the Internet. The client device switches between receiving data from the managed network to receiving data from the unmanaged network. The interactive content that is received over the unmanaged network is provided to display device associated with the client device of the user. The broadcast content signal may contain a plurality of broadcast programs and the client device selectively outputs one of the broadcast programs to an associated display device. The interactive content may originate from one or more sources. For example, the interactive content may be composed of a template that originates at the processing office along with video content that comes from a remote server. The processing office can gather the interactive content, stitch the interactive content together, encoded the interactive content into a format decodable by the client device and transmit the interactive content to the client device over the unmanaged network.

In certain embodiments, both the managed and the unmanaged networks may operate over a single communications link. For example, the unmanaged network may be the Internet using an IP protocol over a cable or DSL link and the managed network may be an IP protocol television network that broadcasts television programs. In embodiments of the invention, the client device includes ports for both the unmanaged and the managed networks and includes a processor for causing a switch to switch between the two networks, when an event, such as the presence of a trigger occurs. The client device also includes one or more decoders. Each decoder may operate on data from a different network. The client device may also include an infrared port for receiving instructions from a user input device.

In some embodiments, the trigger may not originate within the broadcast content signal. Rather, the trigger may originate as the result of an interaction by the user with an input device that communicates with a client device and causes the client device to switch between networks. For example, a user may be viewing a satellite broadcast that is presented to the user's television through a client device. Upon receipt of a request for an interactive session resulting from a user pressing a button on a remote control device, the client device switches between presenting the satellite broadcast and providing content over the unmanaged network. The client device will request an interactive session with a processing office and interactive content will be provided through the processing office. The client device will receive transmissions from the processing office and will decode and present the interactive content to the user's television.

In another embodiment, a tuner such as a QAM tuner is provider either in separate box coupled to or as part of a television. The QAM tuner receives in broadcast cable content. Coupled to the television is an IP device that provides for connection to the Internet using IP (Internet Protocol) communications. The IP device may be external or internal to the television. The broadcast content contains a trigger signal that causes a processor within the television to direct a signal to the IP device that forwards a request for an interactive session over an IP connection to a processing office. The processing office assigns a processor, which then retrieves and stitches together interactive content and provides the interactive content to the IP device. The IP device then provides the interactive content to the television. The television may include a decoder or the IP device may include a decoder.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing a communications environment for implementing one version of the present invention;

FIG. 1A shows the regional processing offices and the video content distribution network;

FIG. 1B is a sample composite stream presentation and interaction layout file;

FIG. 1C shows the construction of a frame within the authoring environment;

FIG. 1D shows breakdown of a frame by macroblocks into elements;

FIG. 2 is a diagram showing multiple sources composited onto a display;

FIG. 3 is a diagram of a system incorporating grooming;

FIG. 4 is a diagram showing a video frame prior to grooming, after grooming, and with a video overlay in the groomed section;

FIG. 5 is a diagram showing how grooming is done, for example, removal of B-frames;

FIG. 6 is a diagram showing an MPEG frame structure;

FIG. 7 is a flow chart showing the grooming process for I, B, and P frames;

FIG. 8 is a diagram depicting removal of region boundary motion vectors;

FIG. 9 is a diagram showing the reordering of the DCT coefficients;

FIG. 10 shows an alternative groomer;

FIG. 11 is an example of a video frame;

FIG. 12 is a diagram showing video frames starting in random positions relative to each other;

FIG. 13 is a diagram of a display with multiple MPEG elements composited within the picture;

FIG. 14 is a diagram showing the slice breakdown of a picture consisting of multiple elements;

FIG. 15 is a diagram showing slice based encoding in preparation for stitching;

FIG. 16 is a diagram detailing the compositing of a video element into a picture;

FIG. 17 is a diagram detailing compositing of a 16×16 sized macroblock element into a background comprised of 24×24 sized macroblocks;

FIG. 18 is a flow chart showing the steps involved in encoding and building a composited picture;

FIG. 19 is a diagram providing a simple example of grooming;

FIG. 20 is a diagram showing that the composited element does not need to be rectangular nor contiguous;

FIG. 21 shows a diagram of elements on a screen wherein a single element is non-contiguous;

FIG. 22 shows a groomer for grooming linear broadcast content for multicasting to a plurality of processing offices and/or session processors;

FIG. 23 shows an example of a customized mosaic when displayed on a display device;

FIG. 24 is a diagram of an IP based network for providing interactive MPEG content;

FIG. 25 is a diagram of a cable based network for providing interactive MPEG content;

FIG. 26 is a flow-chart of the resource allocation process for a load balancer for use with a cable based network;

FIG. 27 is a system diagram used to show communication between cable network elements for load balancing;

FIG. 28 shows a managed broadcast content satellite network that can provide interactive content to subscribers through an unmanaged IP network; and

FIG. 29 shows another environment where a client device receives broadcast content through a managed network and interactive content may be requested and is provided through an unmanaged network.

### DETAILED DESCRIPTION OF SPECIFIC EMBODIMENTS

As used in the following detailed description and in the appended claims the term “region” shall mean a logical grouping of MPEG (Motion Picture Expert Group) slices that are either contiguous or non-contiguous. When the term MPEG is used it shall refer to all variants of the MPEG standard including MPEG-2 and MPEG-4. The present invention as described in the embodiments below provides an environment for interactive MPEG content and communications between a processing office and a client device having an associated display, such as a television. Although the present invention specifically references the MPEG specification and encoding, principles of the invention may be employed with other encoding techniques that are based upon block-based transforms. As used in the following specification and appended claims, the terms encode, encoded, and encoding shall refer to the process of compressing a digital data signal and formatting the compressed digital data signal to a protocol or standard. Encoded video data can be in any state other than a spatial representation. For example, encoded video data may be transform coded, quantized, and entropy encoded or any combination thereof. Therefore, data that has been transform coded will be considered to be encoded.

Although the present application refers to the display device as a television, the display device may be a cell phone, a Personal Digital Assistant (PDA) or other device that includes a display. A client device including a decoding device, such as a set-top box that can decode MPEG content, is associated with the display device of the user. In certain embodiments, the decoder may be part of the display device. The interactive MPEG content is created in an authoring environment allowing an application designer to design the interactive MPEG content creating an application having one or more scenes from various elements including video content from content providers and linear broadcasters. An application file is formed in an Active Video Markup Language (AVML). The AVML file produced by the authoring environment is an XML-based file defining the video graphical elements (i.e. MPEG slices) within a single frame/page, the sizes of the video graphical elements, the layout of the video graphical elements within the page/frame for each scene, links to the video graphical elements, and any scripts for the scene. In certain embodiments, an AVML file may be authored directly as opposed to being authored in a text editor or generated by an authoring environment. The video graphical elements may be static graphics, dynamic graphics, or video content. It should be recognized that each element within a scene is really a sequence of images and a static graphic is an image that is repeatedly displayed and does not change over time. Each of the elements may be an MPEG object that can include both MPEG data for graphics and operations associated with the graphics. The interactive MPEG content can include multiple interactive MPEG objects within a scene with which a user can interact. For example, the scene may include a button MPEG object that provides encoded MPEG data forming the video graphic for the object and also includes a procedure for keeping track of the button state. The MPEG objects may work in coordination with the scripts. For example, an MPEG button object may keep track of its state (on/off), but a script within the scene will determine what occurs when that button is pressed. The script may associate the button state with a video program so that the button will indicate whether the video content is playing or stopped. MPEG objects always have an associated action as part of the object. In certain embodiments, the MPEG objects, such as a button MPEG object, may perform actions beyond keeping track of the status of the button. In such, embodiments, the MPEG object may also include a call to an external program, wherein the MPEG object will access the program when the button graphic is engaged. Thus, for a play/pause MPEG object button, the MPEG object may include code that keeps track of the state of the button, provides a graphical overlay based upon a state change, and/or causes a video player object to play or pause the video content depending on the state of the button.

Once an application is created within the authoring environment, and an interactive session is requested by a requesting client device, the processing office assigns a processor for the interactive session.

The assigned processor operational at the processing office runs a virtual machine and accesses and runs the requested application. The processor prepares the graphical part of the scene for transmission in the MPEG format. Upon receipt of the MPEG transmission by the client device and display on the user's display, a user can interact with the displayed content by using an input device in communication with the client device. The client device sends input requests from the user through a communication network to the application running on the assigned processor at the processing office or other remote location. In response, the assigned processor updates the graphical layout based upon the request and the state of the MPEG objects hereinafter referred to in total as the application state. New elements may be added to the scene or replaced within the scene or a completely new scene may be created. The assigned processor collects the elements and the objects for the scene, and either the assigned processor or another processor processes the data and operations according to the object(s) and produces the revised graphical representation in an MPEG format that is transmitted to the transceiver for display on the user's television. Although the above passage indicates that the assigned processor is located at the processing office, the assigned processor may be located at a remote location and need only be in communication with the processing office through a network connection. Similarly, although the assigned processor is described as handling all transactions with the client device, other processors may also be involved with requests and assembly of the content (MPEG objects) of the graphical layout for the application.

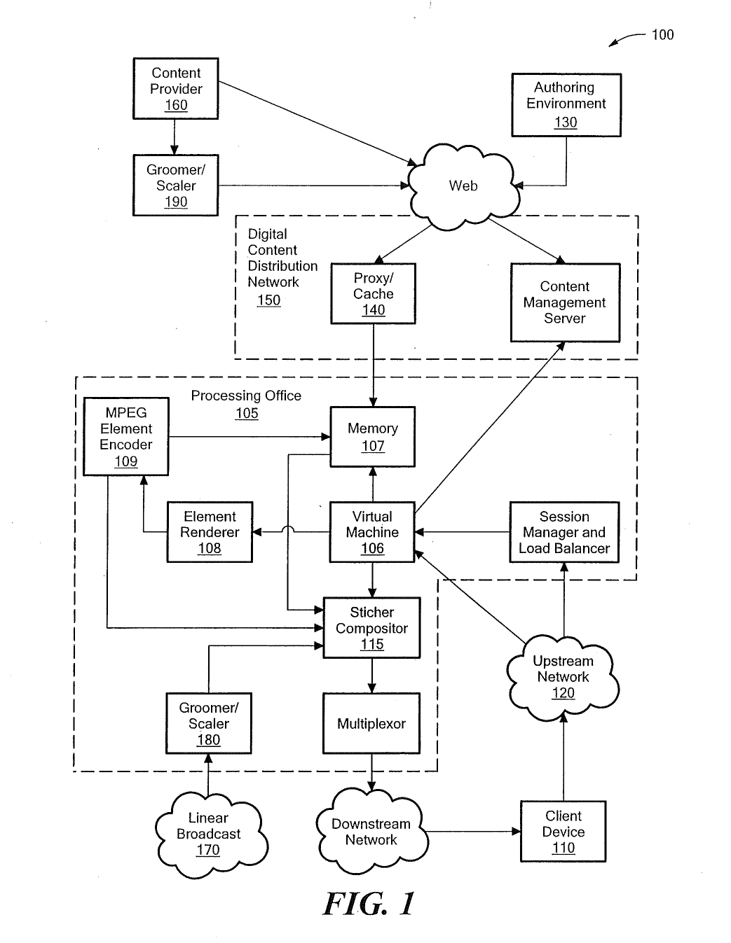

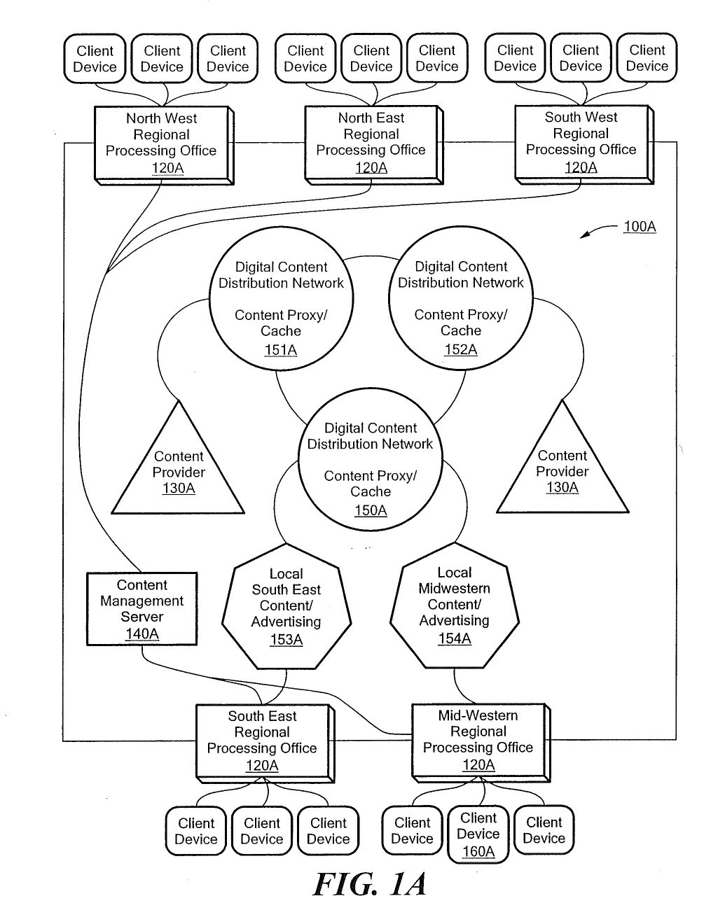

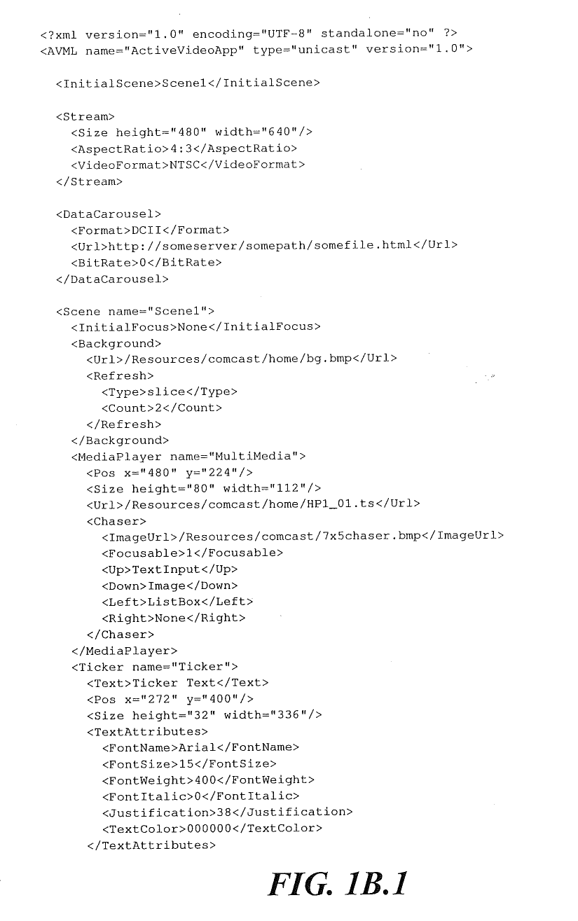

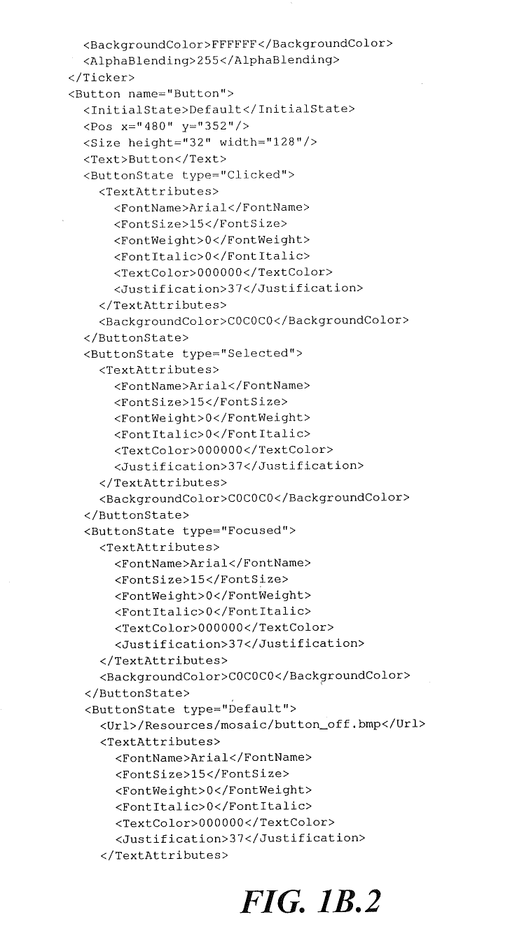

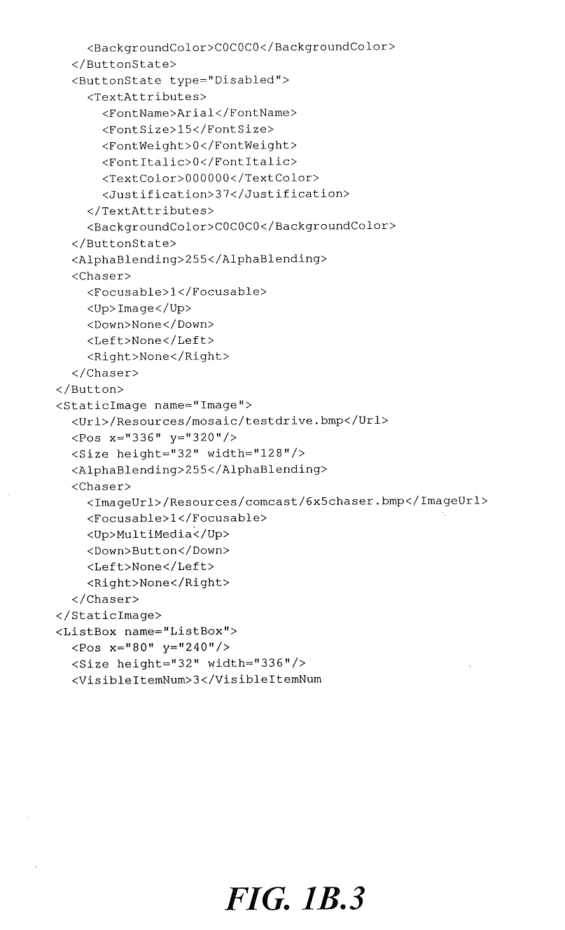

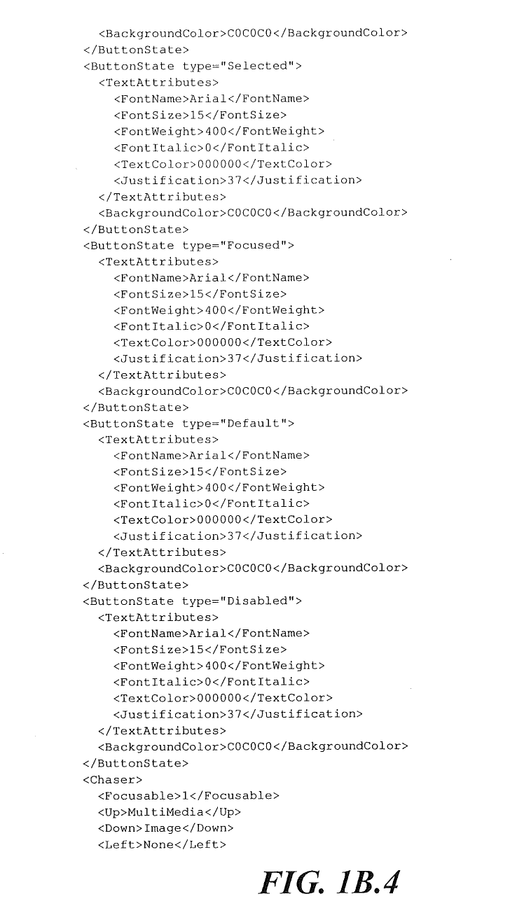

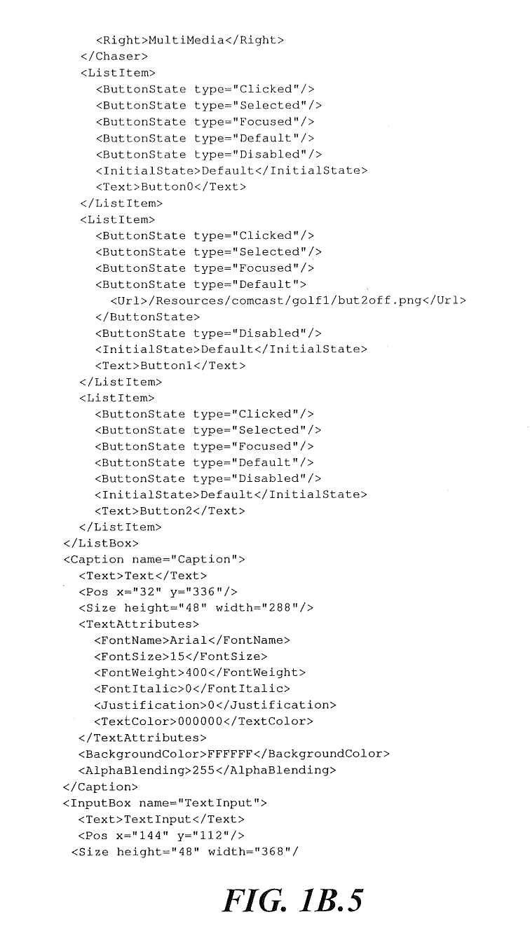

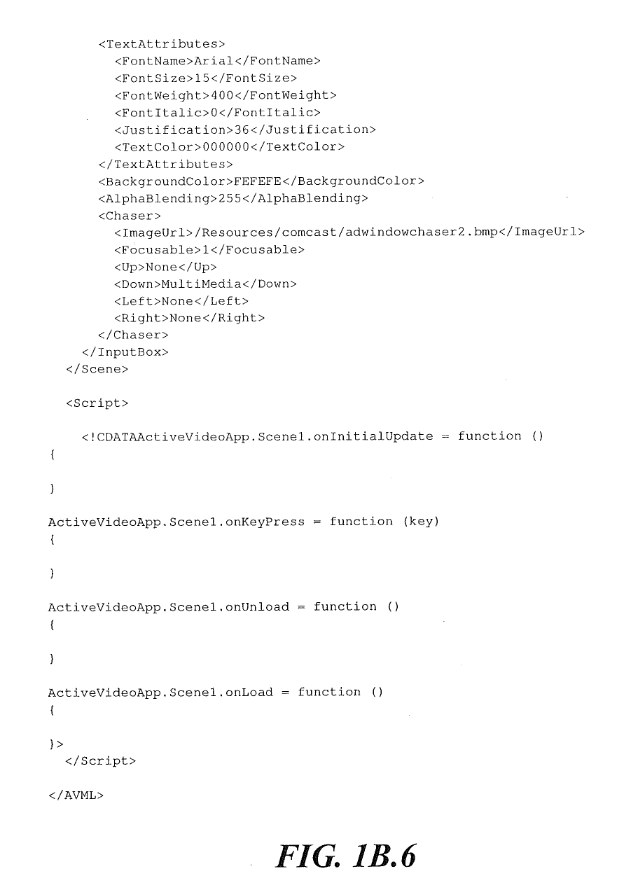

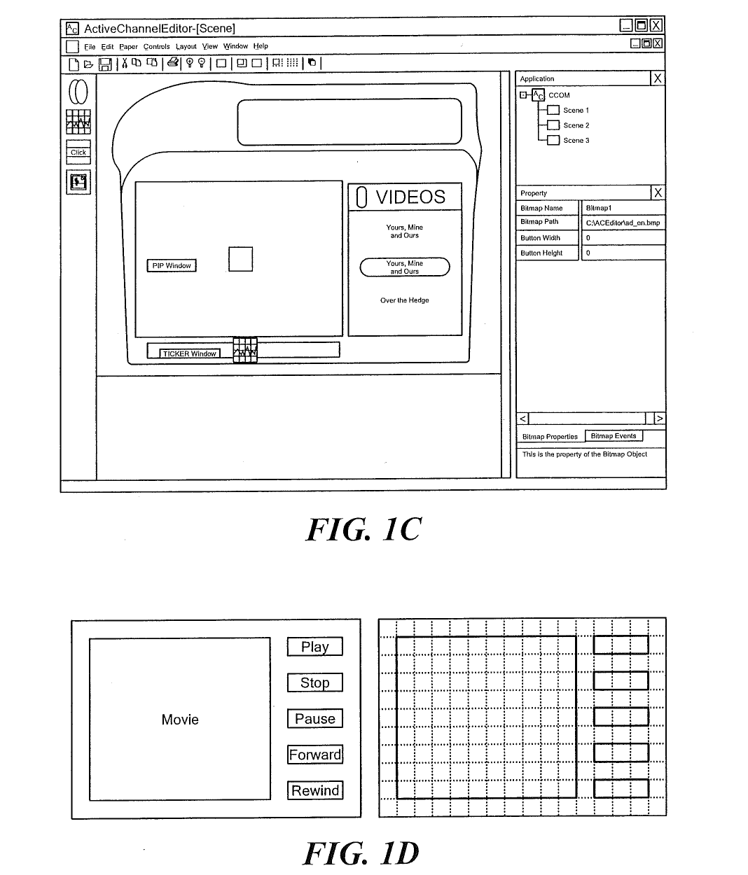

FIG. 1 is a block diagram showing a communications environment 100 for implementing one version of the present invention. The communications environment 100 allows an applications programmer to create an application for two-way interactivity with an end user. The end user views the application on a client device 110, such as a television, and can interact with the content by sending commands upstream through an upstream network 120 wherein upstream and downstream may be part of the same network or a separate network providing the return path link to the processing office. The application programmer creates an application that includes one or more scenes. Each scene is the equivalent of an HTML webpage except that each element within the scene is a video sequence. The application programmer designs the graphical representation of the scene and incorporates links to elements, such as audio and video files and objects, such as buttons and controls for the scene. The application programmer uses a graphical authoring tool 130 to graphically select the objects and elements. The authoring environment 130 may include a graphical interface that allows an application programmer to associate methods with elements creating video objects. The graphics may be MPEG encoded video, groomed MPEG video, still images or video in another format. The application programmer can incorporate content from a number of sources including content providers 160 (news sources, movie studios, RSS feeds etc.) and linear broadcast sources (broadcast media and cable, on demand video sources and web-based video sources) 170 into an application. The application programmer creates the application as a file in AVML (active video mark-up language) and sends the application file to a proxy/cache 140 within a video content distribution network 150. The AVML file format is an XML format. For example see FIG. 1B that shows a sample AVML file.

The content provider 160 may encode the video content as MPEG video/audio or the content may be in another graphical format (e.g. JPEG, BITMAP, H263, H264, VC-1 etc.). The content may be subsequently groomed and/or scaled in a Groomer/Scaler 190 to place the content into a preferable encoded MPEG format that will allow for stitching. If the content is not placed into the preferable MPEG format, the processing office will groom the format when an application that requires the content is requested by a client device. Linear broadcast content 170 from broadcast media services, like content from the content providers, will be groomed. The linear broadcast content is preferably groomed and/or scaled in Groomer/Scaler 180 that encodes the content in the preferable MPEG format for stitching prior to passing the content to the processing office.

The video content from the content producers 160 along with the applications created by application programmers are distributed through a video content distribution network 150 and are stored at distribution points 140. These distribution points are represented as the proxy/cache within FIG. 1. Content providers place their content for use with the interactive processing office in the video content distribution network at a proxy/cache 140 location. Thus, content providers 160 can provide their content to the cache 140 of the video content distribution network 150 and one or more processing office that implements the present architecture may access the content through the video content distribution network 150 when needed for an application. The video content distribution network 150 may be a local network, a regional network or a global network. Thus, when a virtual machine at a processing office requests an application, the application can be retrieved from one of the distribution points and the content as defined within the application's AVML file can be retrieved from the same or a different distribution point.

An end user of the system can request an interactive session by sending a command through the client device 110, such as a set-top box, to a processing office 105. In FIG. 1, only a single processing office is shown. However, in real-world applications, there may be a plurality of processing offices located in different regions, wherein each of the processing offices is in communication with a video content distribution network as shown in FIG. 1B. The processing office 105 assigns a processor for the end user for an interactive session. The processor maintains the session including all addressing and resource allocation. As used in the specification and the appended claims the term “virtual machine” 106 shall refer to the assigned processor, as well as, other processors at the processing office that perform functions, such as session management between the processing office and the client device as well as resource allocation (i.e. assignment of a processor for an interactive session).

The virtual machine 106 communicates its address to the client device 110 and an interactive session is established. The user can then request presentation of an interactive application (AVML) through the client device 110. The request is received by the virtual machine 106 and in response, the virtual machine 106 causes the AVML file to be retrieved from the proxy/cache 140 and installed into a memory cache 107 that is accessible by the virtual machine 106. It should be recognized that the virtual machine 106 may be in simultaneous communication with a plurality of client devices 110 and the client devices may be different device types. For example, a first device may be a cellular telephone, a second device may be a set-top box, and a third device may be a personal digital assistant wherein each device access the same or a different application.

In response to a request for an application, the virtual machine 106 processes the application and requests elements and MPEG objects that are part of the scene to be moved from the proxy/cache into memory 107 associated with the virtual machine 106. An MPEG object includes both a visual component and an actionable component. The visual component may be encoded as one or more MPEG slices or provided in another graphical format. The actionable component may be storing the state of the object, may include performing computations, accessing an associated program, or displaying overlay graphics to identify the graphical component as active. An overlay graphic may be produced by a signal being transmitted to a client device wherein the client device creates a graphic in the overlay plane on the display device. It should be recognized that a scene is not a static graphic, but rather includes a plurality of video frames wherein the content of the frames can change over time.

The virtual machine 106 determines based upon the scene information, including the application state, the size and location of the various elements and objects for a scene. Each graphical element may be formed from contiguous or non-contiguous MPEG slices. The virtual machine keeps track of the location of all of the slices for each graphical element. All of the slices that define a graphical element form a region. The virtual machine 106 keeps track of each region. Based on the display position information within the AVML file, the slice positions for the elements and background within a video frame are set. If the graphical elements are not already in a groomed format, the virtual machine passes that element to an element renderer. The renderer renders the graphical element as a bitmap and the renderer passes the bitmap to an MPEG element encoder 109. The MPEG element encoder encodes the bitmap as an MPEG video sequence. The MPEG encoder processes the bitmap so that it outputs a series of P-frames. An example of content that is not already pre-encoded and pre-groomed is personalized content. For example, if a user has stored music files at the processing office and the graphic element to be presented is a listing of the user's music files, this graphic would be created in real-time as a bitmap by the virtual machine. The virtual machine would pass the bitmap to the element renderer 108 which would render the bitmap and pass the bitmap to the MPEG element encoder 109 for grooming.

After the graphical elements are groomed by the MPEG element encoder, the MPEG element encoder 109 passes the graphical elements to memory 107 for later retrieval by the virtual machine 106 for other interactive sessions by other users. The MPEG encoder 109 also passes the MPEG encoded graphical elements to the stitcher 115. The rendering of an element and MPEG encoding of an element may be accomplished in the same or a separate processor from the virtual machine 106. The virtual machine 106 also determines if there are any scripts within the application that need to be interpreted. If there are scripts, the scripts are interpreted by the virtual machine 106.

Each scene in an application can include a plurality of elements including static graphics, object graphics that change based upon user interaction, and video content. For example, a scene may include a background (static graphic), along with a media player for playback of audio video and multimedia content (object graphic) having a plurality of buttons, and a video content window (video content) for displaying the streaming video content. Each button of the media player may itself be a separate object graphic that includes its own associated methods.

The virtual machine 106 acquires each of the graphical elements (background, media player graphic, and video frame) for a frame and determines the location of each element. Once all of the objects and elements (background, video content) are acquired, the elements and graphical objects are passed to the stitcher/compositor 115 along with positioning information for the elements and MPEG objects. The stitcher 115 stitches together each of the elements (video content, buttons, graphics, background) according to the mapping provided by the virtual machine 106. Each of the elements is placed on a macroblock boundary and when stitched together the elements form an MPEG video frame. On a periodic basis all of the elements of a scene frame are encoded to form a reference P-frame in order to refresh the sequence and avoid dropped macroblocks. The MPEG video stream is then transmitted to the address of client device through the down stream network. The process continues for each of the video frames. Although the specification refers to MPEG as the encoding process, other encoding processes may also be used with this system.

The virtual machine 106 or other processor or process at the processing office 105 maintains information about each of the elements and the location of the elements on the screen. The virtual machine 106 also has access to the methods for the objects associated with each of the elements. For example, a media player may have a media player object that includes a plurality of routines. The routines can include, play, stop, fast forward, rewind, and pause. Each of the routines includes code and upon a user sending a request to the processing office 105 for activation of one of the routines, the object is accessed and the routine is run. The routine may be a JAVA-based applet, a script to be interpreted, or a separate computer program capable of being run within the operating system associated with the virtual machine.

The processing office 105 may also create a linked data structure for determining the routine to execute or interpret based upon a signal received by the processor from the client device associated with the television. The linked data structure may be formed by an included mapping module. The data structure associates each resource and associated object relative to every other resource and object. For example, if a user has already engaged the play control, a media player object is activated and the video content is displayed. As the video content is playing in a media player window, the user can depress a directional key on the user's remote control. In this example, the depression of the directional key is indicative of pressing a stop button. The transceiver produces a directional signal and the assigned processor receives the directional signal. The virtual machine 106 or other processor at the processing office 105 accesses the linked data structure and locates the element in the direction of the directional key press. The database indicates that the element is a stop button that is part of a media player object and the processor implements the routine for stopping the video content. The routine will cause the requested content to stop. The last video content frame will be frozen and a depressed stop button graphic will be interwoven by the stitcher module into the frame. The routine may also include a focus graphic to provide focus around the stop button. For example, the virtual machine can cause the stitcher to enclose the graphic having focus with a boarder that is 1 macroblock wide. Thus, when the video frame is decoded and displayed, the user will be able to identify the graphic/object that the user can interact with. The frame will then be passed to a multiplexor and sent through the downstream network to the client device. The MPEG encoded video frame is decoded by the client device displayed on either the client device (cell phone, PDA) or on a separate display device (monitor, television). This process occurs with a minimal delay. Thus, each scene from an application results in a plurality of video frames each representing a snapshot of the media player application state.

The virtual machine 106 will repeatedly receive commands from the client device and in response to the commands will either directly or indirectly access the objects and execute or interpret the routines of the objects in response to user interaction and application interaction model. In such a system, the video content material displayed on the television of the user is merely decoded MPEG content and all of the processing for the interactivity occurs at the processing office and is orchestrated by the assigned virtual machine. Thus, the client device only needs a decoder and need not cache or process any of the content.

It should be recognized that through user requests from a client device, the processing office could replace a video element with another video element. For example, a user may select from a list of movies to display and therefore a first video content element would be replaced by a second video content element if the user selects to switch between two movies. The virtual machine, which maintains a listing of the location of each element and region forming an element, can easily replace elements within a scene creating a new MPEG video frame wherein the frame is stitched together including the new element in the stitcher 115.

FIG. 1A shows the interoperation between the digital content distribution network 100A, the content providers 110A and the processing offices 120A. In this example, the content providers 130A distribute content into the video content distribution network 100A. Either the content providers 130A or processors associated with the video content distribution network convert the content to an MPEG format that is compatible with the processing office's 120A creation of interactive MPEG content. A content management server 140A of the digital content distribution network 100A distributes the MPEG-encoded content among proxy/caches 150A-154A located in different regions if the content is of a global/national scope. If the content is of a regional/local scope, the content will reside in a regional/local proxy/cache. The content may be mirrored throughout the country or world at different locations in order to increase access times. When an end user, through their client device 160A, requests an application from a regional processing office, the regional processing office will access the requested application. The requested application may be located within the video content distribution network or the application may reside locally to the regional processing office or within the network of interconnected processing offices. Once the application is retrieved, the virtual machine assigned at the regional processing office will determine the video content that needs to be retrieved. The content management server 140A assists the virtual machine in locating the content within the video content distribution network. The content management server 140A can determine if the content is located on a regional or local proxy/cache and also locate the nearest proxy/cache. For example, the application may include advertising and the content management server will direct the virtual machine to retrieve the advertising from a local proxy/cache. As shown in FIG. 1A., both the Midwestern and Southeastern regional processing offices 120A also have local proxy/caches 153A, 154A. These proxy/caches may contain local news and local advertising. Thus, the scenes presented to an end user in the Southeast may appear different to an end user in the Midwest. Each end user may be presented with different local news stories or different advertising. Once the content and the application are retrieved, the virtual machine processes the content and creates an MPEG video stream. The MPEG video stream is then directed to the requesting client device. The end user may then interact with the content requesting an updated scene with new content and the virtual machine at the processing office will update the scene by requesting the new video content from the proxy/cache of the video content distribution network.

### Authoring Environment

The authoring environment includes a graphical editor as shown in FIG. 1C for developing interactive applications. An application includes one or more scenes. As shown in FIG. 1B the application window shows that the application is composed of three scenes (scene 1, scene 2 and scene 3). The graphical editor allows a developer to select elements to be placed into the scene forming a display that will eventually be shown on a display device associated with the user. In some embodiments, the elements are dragged-and-dropped into the application window. For example, a developer may want to include a media player object and media player button objects and will select these elements from a toolbar and drag and drop the elements in the window. Once a graphical element is in the window, the developer can select the element and a property window for the element is provided. The property window includes at least the location of the graphical element (address), and the size of the graphical element. If the graphical element is associated with an object, the property window will include a tab that allows the developer to switch to a bitmap event screen and alter the associated object parameters. For example, a user may change the functionality associated with a button or may define a program associated with the button.

As shown in FIG. 1D, the stitcher of the system creates a series of MPEG frames for the scene based upon the AVML file that is the output of the authoring environment. Each element/graphical object within a scene is composed of different slices defining a region. A region defining an element/object may be contiguous or non-contiguous. The system snaps the slices forming the graphics on a macro-block boundary. Each element need not have contiguous slices. For example, the background has a number of non-contiguous slices each composed of a plurality of macroblocks. The background, if it is static, can be defined by intracoded macroblocks. Similarly, graphics for each of the buttons can be intracoded; however the buttons are associated with a state and have multiple possible graphics. For example, the button may have a first state “off” and a second state “on” wherein the first graphic shows an image of a button in a non-depressed state and the second graphic shows the button in a depressed state. FIG. 1C also shows a third graphical element, which is the window for the movie. The movie slices are encoded with a mix of intracoded and intercoded macroblocks and dynamically changes based upon the content. Similarly if the background is dynamic, the background can be encoded with both intracoded and interceded macroblocks, subject to the requirements below regarding grooming.

When a user selects an application through a client device, the processing office will stitch together the elements in accordance with the layout from the graphical editor of the authoring environment. The output of the authoring environment includes an Active Video Mark-up Language file (AVML) The AVML file provides state information about multi-state elements such as a button, the address of the associated graphic, and the size of the graphic. The AVML file indicates the locations within the MPEG frame for each element, indicates the objects that are associated with each element, and includes the scripts that define changes to the MPEG frame based upon user's actions. For example, a user may send an instruction signal to the processing office and the processing office will use the AVML file to construct a set of new MPEG frames based upon the received instruction signal. A user may want to switch between various video elements and may send an instruction signal to the processing office. The processing office will remove a video element within the layout for a frame and will select the second video element causing the second video element to be stitched into the MPEG frame at the location of the first video element. This process is described below.

### AVML File

The application programming environment outputs an AVML file. The AVML file has an XML-based syntax. The AVML file syntax includes a root object <AVML>. Other top level tags include <initialscene> that specifies the first scene to be loaded when an application starts. The <script> tag identifies a script and a <scene> tag identifies a scene. There may also be lower level tags to each of the top level tags, so that there is a hierarchy for applying the data within the tag. For example, a top level stream tag may include <aspect ratio> for the video stream, <video format>, <bit rate>, <audio format> and <audio bit rate>. Similarly, a scene tag may include each of the elements within the scene. For example, <background> for the background, <button> for a button object, and <static image> for a still graphic. Other tags include <size> and <pos> for the size and position of an element and may be lower level tags for each element within a scene. An example of an AVML file is provided in FIG. 1B.

### Groomer

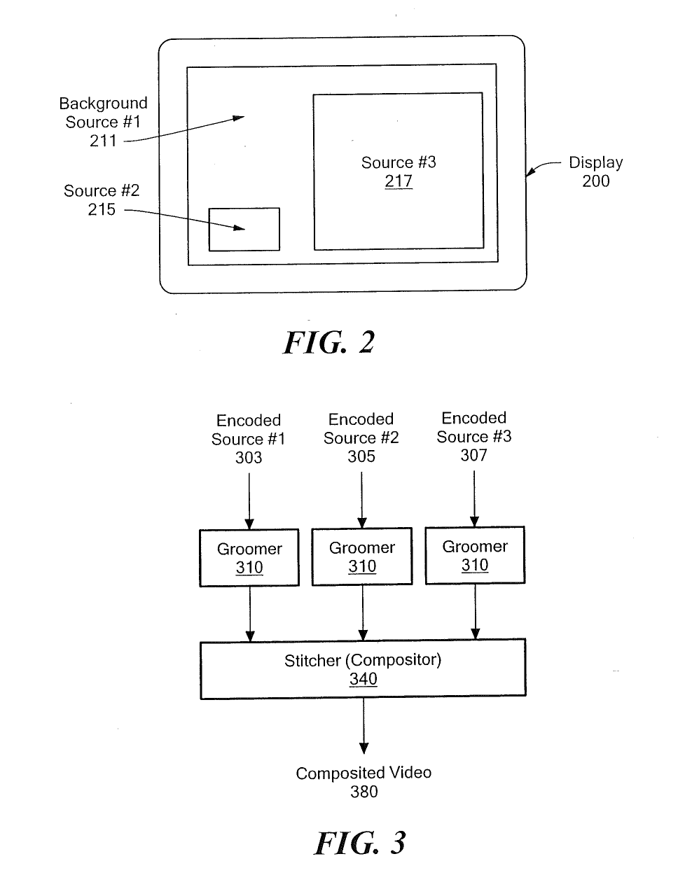

FIG. 2 is a diagram of a representative display that could be provided to a television of a requesting client device. The display 200 shows three separate video content elements appearing on the screen. Element #1 211 is the background in which element #2 215 and element #3 217 are inserted.

FIG. 3 shows a first embodiment of a system that can generate the display of FIG. 2. In this diagram, the three video content elements come in as encoded video: element #1 303, element #2 305, and element #3 307. The groomers 310 each receive an encoded video content element and the groomers process each element before the stitcher 340 combines the groomed video content elements into a single composited video 380. It should be understood by one of ordinary skill in the art that groomers 310 may be a single processor or multiple processors that operate in parallel. The groomers may be located either within the processing office, at content providers' facilities, or linear broadcast provider's facilities. The groomers may not be directly connected to the stitcher, as shown in FIG. 1 wherein the groomers 190 and 180 are not directly coupled to stitcher 115.

The process of stitching is described below and can be performed in a much more efficient manner if the elements have been groomed first.

Grooming removes some of the interdependencies present in compressed video. The groomer will convert I and B frames to P frames and will fix any stray motion vectors that reference a section of another frame of video that has been cropped or removed. Thus, a groomed video stream can be used in combination with other groomed video streams and encoded still images to form a composite MPEG video stream. Each groomed video stream includes a plurality of frames and the frames can be can be easily inserted into another groomed frame wherein the composite frames are grouped together to form an MPEG video stream. It should be noted that the groomed frames may be formed from one or more MPEG slices and may be smaller in size than an MPEG video frame in the MPEG video stream.

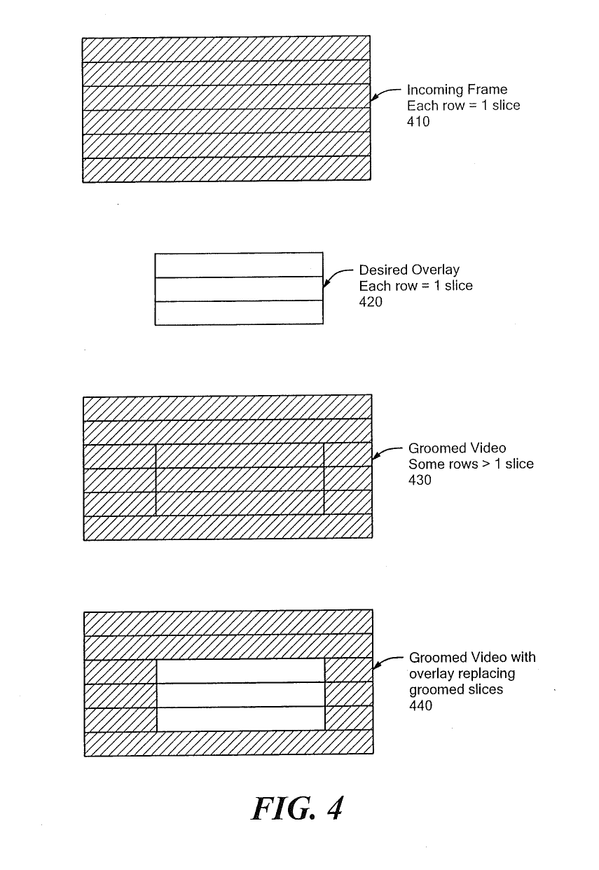

FIG. 4 is an example of a composite video frame that contains a plurality of elements 410, 420. This composite video frame is provided for illustrative purposes. The groomers as shown in FIG. 1 only receive a single element and groom the element (video sequence), so that the video sequence can be stitched together in the stitcher. The groomers do not receive a plurality of elements simultaneously. In this example, the background video frame 410 includes 1 row per slice (this is an example only; the row could be composed of any number of slices). As shown in FIG. 1, the layout of the video frame including the location of all of the elements within the scene is defined by the application programmer in the AVML file. For example, the application programmer may design the background element for a scene. Thus, the application programmer may have the background encoded as MPEG video and may groom the background prior to having the background placed into the proxy cache 140. Therefore, when an application is requested, each of the elements within the scene of the application may be groomed video and the groomed video can easily be stitched together. It should be noted that although two groomers are shown within FIG. 1 for the content provider and for the linear broadcasters, groomers may be present in other parts of the system.

As shown, video element 420 is inserted within the background video frame 410 (also for example only; this element could also consist of multiple slices per row). If a macroblock within the original video frame 410 references another macroblock in determining its value and the reference macroblock is removed from the frame because the video image 420 is inserted in its place, the macroblocks value needs to be recalculated. Similarly, if a macroblock references another macroblock in a subsequent frame and that macroblock is removed and other source material is inserted in its place, the macroblock values need to be recalculated. This is addressed by grooming the video 430. The video frame is processed so that the rows contain multiple slices some of which are specifically sized and located to match the substitute video content. After this process is complete, it is a simple task to replace some of the current slices with the overlay video resulting in a groomed video with overlay 440. The groomed video stream has been specifically defined to address that particular overlay. A different overlay would dictate different grooming parameters. Thus, this type of grooming addresses the process of segmenting a video frame into slices in preparation for stitching. It should be noted that there is never a need to add slices to the overlay element. Slices are only added to the receiving element, that is, the element into which the overlay will be placed. The groomed video stream can contain information about the stream's groomed characteristics. Characteristics that can be provided include: 1. the locations for the upper left and lower right corners of the groomed window. 2. The location of upper left corner only and then the size of the window. The size of the slice accurate to the pixel level.

There are also two ways to provide the characteristic information in the video stream. The first is to provide that information in the slice header. The second is to provide the information in the extended data slice structure. Either of these options can be used to successfully pass the necessary information to future processing stages, such as the virtual machine and stitcher.

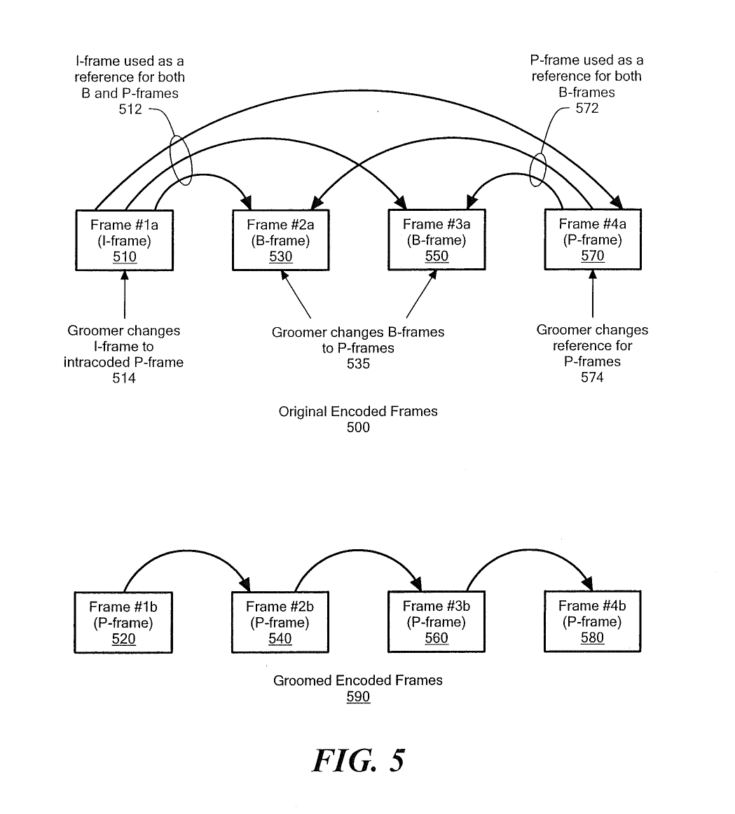

FIG. 5 shows the video sequence for a video graphical element before and after grooming. The original incoming encoded stream 500 has a sequence of MPEG I-frames 510, B-frames 530 550, and P-frames 570 as are known to those of ordinary skill in the art. In this original stream, the I-frame is used as a reference 512 for all the other frames, both B and P. This is shown via the arrows from the I-frame to all the other frames. Also, the P-frame is used as a reference frame 572 for both B-frames. The groomer processes the stream and replaces all the frames with P-frames. First the original I-frame 510 is converted to an intracoded P-frame 520. Next the B-frames 530, 550 are converted 535 to P-frames 540 and 560 and modified to reference only the frame immediately prior. Also, the P-frames 570 are modified to move their reference 574 from the original I-frame 510 to the newly created P-frame 560 immediately in preceding themselves. The resulting P-frame 580 is shown in the output stream of groomed encoded frames 590.

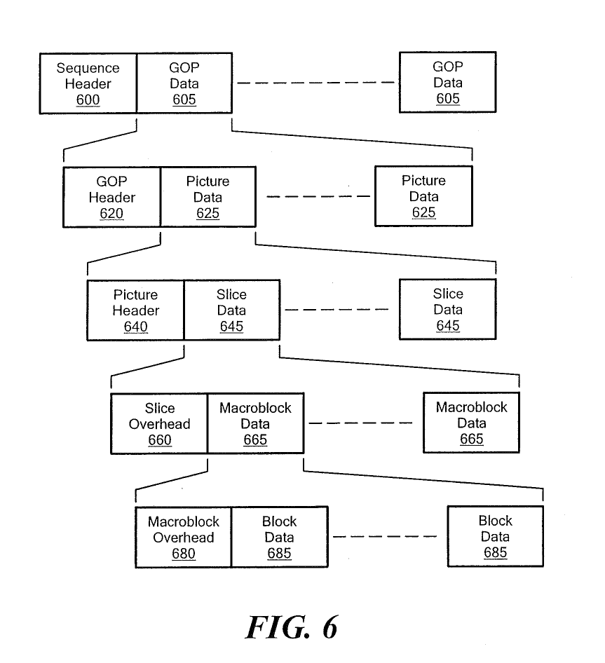

FIG. 6 is a diagram of a standard MPEG-2 bitstream syntax. MPEG-2 is used as an example and the invention should not be viewed as limited to this example. The hierarchical structure of the bitstream starts at the sequence level. This contains the sequence header 600 followed by group of picture (GOP) data 605. The GOP data contains the GOP header 620 followed by picture data 625. The picture data 625 contains the picture header 640 followed by the slice data 645. The slice data 645 consists of some slice overhead 660 followed by macroblock data 665. Finally, the macroblock data 665 consists of some macroblock overhead 680 followed by block data 685 (the block data is broken down further but that is not required for purposes of this reference). Sequence headers act as normal in the groomer. However, there are no GOP headers output of the groomer since all frames are P-frames. The remainder of the headers may be modified to meet the output parameters required.

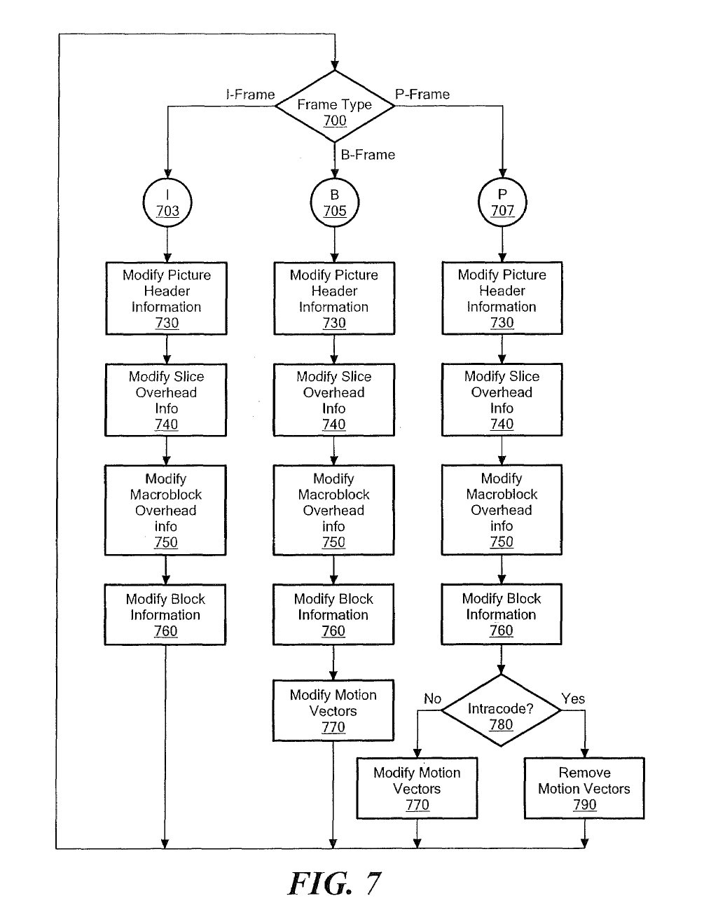

FIG. 7 provides a flow for grooming the video sequence. First the frame type is determining 700: I-frame 703 B-frame 705, or P-frame 707. I-frames 703 as do B-frames 705 need to be converted to P-frames. In addition, I-frames need to match the picture information that the stitcher requires. For example, this information may indicate the encoding parameters set in the picture header. Therefore, the first step is to modify the picture header information 730 so that the information in the picture header is consistent for all groomed video sequences. The stitcher settings are system level settings that may be included in the application. These are the parameters that will be used for all levels of the bit stream. The items that require modification are provided in the table below:

TABLE 1
Picture Header Information

| # | Name | Value |
|---|---|---|
| A | Picture Coding Type | P-Frame |
| B | Intra DC Precision | Match stitcher setting |
| C | Picture structure | Frame |
| D | Frame prediction frame DCT | Match stitcher setting |
| E | Quant scale type | Match stitcher setting |
| F | Intra VLC format | Match stitcher setting |
| G | Alternate scan | Normal scan |
| H | Progressive frame | Progressive scan |

Next, the slice overhead information 740 must be modified. The parameters to modify are given in the table below.

TABLE 2
Slice Overhead Information

| # | Name | Value |
|---|---|---|
| A | Quantizer Scale Code | Will change if there is a “scale type” |
| | | change in the picture header. |

Next, the macroblock overhead 750 information may require modification. The values to be modified are given in the table below.

TABLE 3
Macroblock Information

| # | Name | Value |
|---|---|---|
| A | Macroblock type | Change the variable length |
| | | code from that for an I |
| | | frame to that for a P frame) |
| B | DCT type | Set to frame if not already |
| C | Concealment motion | Removed |
| | vectors | |

Finally, the block information 760 may require modification. The items to modify are given in the table below.

TABLE 4
Block Information

| # | Name | Value |
|---|---|---|
| A | DCT coefficient | Require updating if there were any quantizer |
| | values | changes at the picture or slice level. |
| B | DCT coefficient | Need to be reordered if “alternate scan” was |
| | ordering | changed from what it was before. |

Once the block changes are complete, the process can start over with the next frame of video. If the frame type is a B-frame 705, the same steps required for an I-frame are also required for the B-frame. However, in addition, the motion vectors 770 need to be modified. There are two scenarios: B-frame immediately following an I-frame or P-frame, or a B-frame following another B-frame. Should the B-frame follow either an I or P frame, the motion vector, using the I or P frame as a reference, can remain the same and only the residual would need to change. This may be as simple as converting the forward looking motion vector to be the residual.

For the B-frames that follow another B-frame, the motion vector and its residual will both need to be modified. The second B-frame must now reference the newly converted B to P frame immediately preceding it. First, the B-frame and its reference are decoded and the motion vector and the residual are recalculated. It must be noted that while the frame is decoded to update the motion vectors, there is no need to re-encode the DCT coefficients. These remain the same. Only the motion vector and residual are calculated and modified.

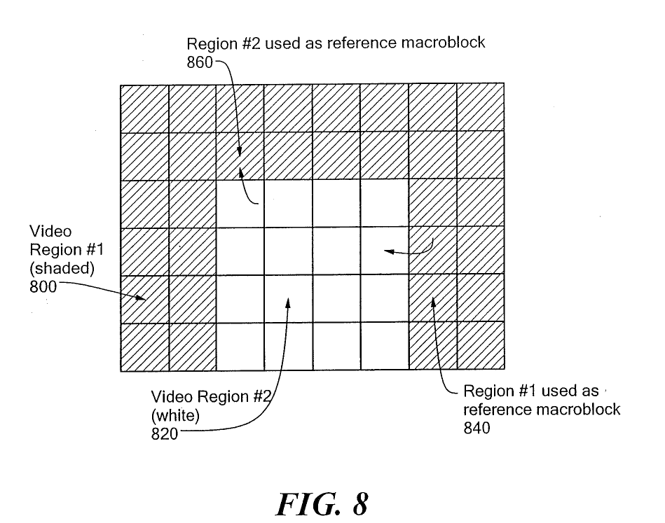

The last frame type is the P-frame. This frame type also follows the same path as an I-frame FIG. 8 diagrams the motion vector modification for macroblocks adjacent to a region boundary. It should be recognized that motion vectors on a region boundary are most relevant to background elements into which other video elements are being inserted. Therefore, grooming of the background elements may be accomplished by the application creator. Similarly, if a video element is cropped and is being inserted into a “hole” in the background element, the cropped element may include motion vectors that point to locations outside of the “hole”. Grooming motion vectors for a cropped image may be done by the content creator if the content creator knows the size that the video element needs to be cropped, or the grooming may be accomplished by the virtual machine in combination with the element renderer and MPEG encoder if the video element to be inserted is larger than the size of the “hole” in the background.

FIG. 8 graphically shows the problems that occur with motion vectors that surround a region that is being removed from a background element. In the example of FIG. 8, the scene includes two regions: #1 800 and #2 820. There are two examples of improper motion vector references. In the first instance, region #2 820 that is inserting into region #1 800 (background), uses region #1 800 (background) as a reference for motion 840. Thus, the motion vectors in region #2 need to be corrected. The second instance of improper motion vector references occurs where region #1 800 uses region #2 820 as a reference for motion 860. The groomer removes these improper motion vector references by either re-encoding them using a frame within the same region or converting the macroblocks to be intracoded blocks.

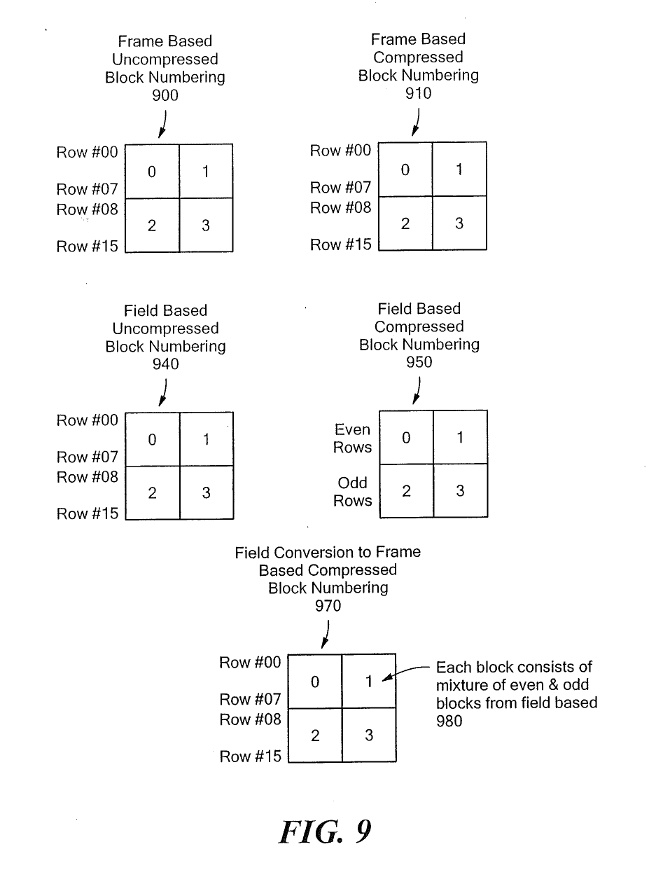

In addition to updating motion vectors and changing frame types, the groomer may also convert field based encoded macroblocks to frame based encoded macroblocks. FIG. 9 shows the conversion of a field based encoded macroblocks to frame based. For reference, a frame based set of blocks 900 is compressed. The compressed block set 910 contains the same information in the same blocks but now it is contained in compressed form. On the other hand, a field based macroblock 940 is also compressed. When this is done, all the even rows (0, 2, 4, 6) are placed in the upper blocks (0 & 1) while the odd rows (1, 3, 5, 7) are placed in the lower blocks (2&3). When the compressed field based macroblock 950 is converted to a frame based macroblock 970, the coefficients need to be moved from one block to another 980. That is, the rows must be reconstructed in numerical order rather than in even odd. Rows 1 & 3, which in the field based encoding were in blocks 2 & 3, are now moved back up to blocks 0 or 1 respectively. Correspondingly, rows 4 & 6 are moved from blocks 0 & 1 and placed down in blocks 2 & 3.

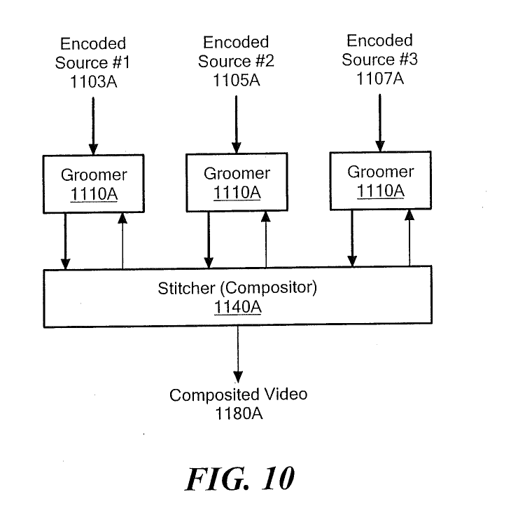

FIG. 10 shows a second embodiment of the grooming platform. All the components are the same as the first embodiment: groomers 1110A and stitcher 1130A. The inputs are also the same: input #1 1103A, input #2 1105A, and input #3 1107A as well as the composited output 1280. The difference in this system is that the stitcher 1140A provides feedback, both synchronization and frame type information, to each of the groomers 1110A. With the synchronization and frame type information, the stitcher 1240 can define a GOP structure that the groomers 1110A follow. With this feedback and the GOP structure, the output of the groomer is no longer P-frames only but can also include I-frames and B-frames. The limitation to an embodiment without feedback is that no groomer would know what type of frame the stitcher was building. In this second embodiment with the feedback from the stitcher 1140A, the groomers 1110A will know what picture type the stitcher is building and so the groomers will provide a matching frame type. This improves the picture quality assuming the same data rate and may decrease the data rate assuming that the quality level is kept constant due to more reference frames and less modification of existing frames while, at the same time, reducing the bit rate since B-frames are allowed.

### Stitcher

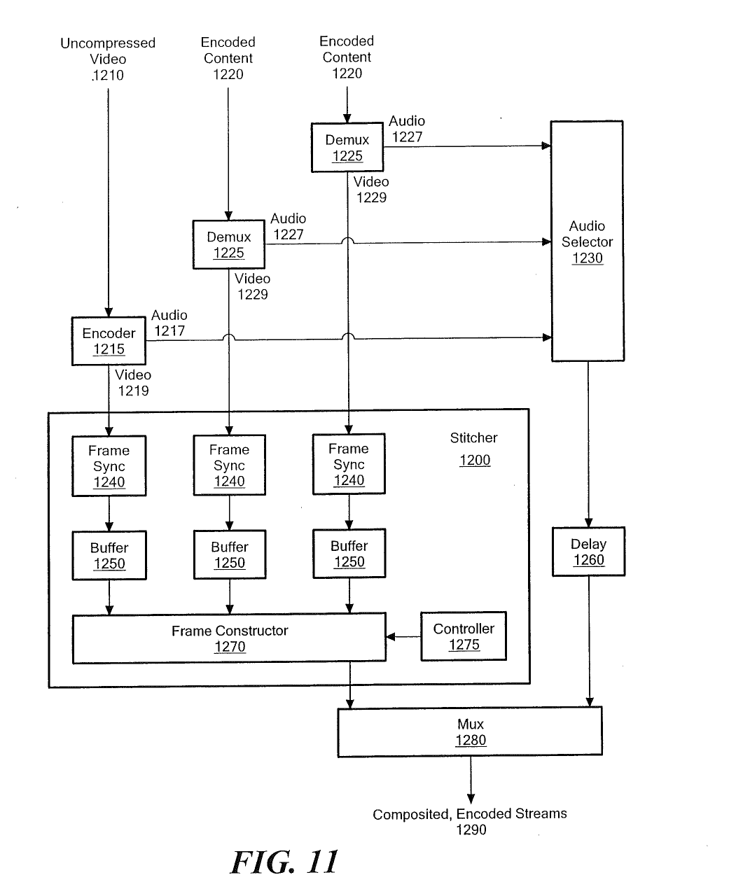

FIG. 11 shows an environment for implementing a stitcher module, such as the stitcher shown in FIG. 1. The stitcher 1200 receives video elements from different sources. Uncompressed content 1210 is encoded in an encoder 1215, such as the MPEG element encoder shown in FIG. 1 prior to its arrival at the stitcher 1200. Compressed or encoded video 1220 does not need to be encoded. There is, however, the need to separate the audio 1217 1227 from the video 1219 1229 in both cases. The audio is fed into an audio selector 1230 to be included in the stream. The video is fed into a frame synchronization block 1240 before it is put into a buffer 1250. The frame constructor 1270 pulls data from the buffers 1250 based on input from the controller 1275. The video out of the frame constructor 1270 is fed into a multiplexer 1280 along with the audio after the audio has been delayed 1260 to align with the video. The multiplexer 1280 combines the audio and video streams and outputs the composited, encoded output streams 1290 that can be played on any standard decoder. Multiplexing a data stream into a program or transport stream is well known to those familiar in the art. The encoded video sources can be real-time, from a stored location, or a combination of both. There is no requirement that all of the sources arrive in real-time.

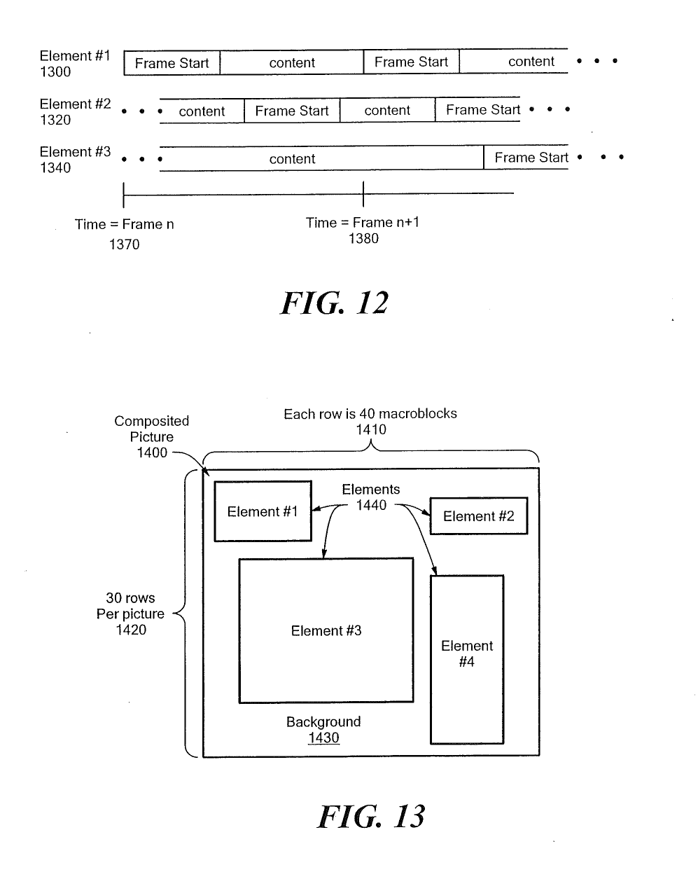

FIG. 12 shows an example of three video content elements that are temporally out of sync. In order to synchronize the three elements, element #1 1300 is used as an “anchor” or “reference” frame. That is, it is used as the master frame and all other frames will be aligned to it (this is for example only; the system could have its own master frame reference separate from any of the incoming video sources). The output frame timing 1370 1380 is set to match the frame timing of element #1 1300. Elements #2 & 3 1320 and 1340 do not align with element #1 1300. Therefore, their frame start is located and they are stored in a buffer. For example, element #2 1320 will be delayed one frame so an entire frame is available before it is composited along with the reference frame. Element #3 is much slower than the reference frame. Element #3 is collected over two frames and presented over two frames. That is, each frame of element #3 1340 is displayed for two consecutive frames in order to match the frame rate of the reference frame. Conversely if a frame, not shown, was running at twice the rate of the reference frame, then every other frame would be dropped (not shown). More than likely all elements are running at almost the same speed so only infrequently would a frame need to be repeated or dropped in order to maintain synchronization.

FIG. 13 shows an example composited video frame 1400. In this example, the frame is made up of 40 macroblocks per row 1410 with 30 rows per picture 1420. The size is used as an example and it not intended to restrict the scope of the invention. The frame includes a background 1430 that has elements 1440 composited in various locations. These elements 1440 can be video elements, static elements, etc. That is, the frame is constructed of a full background, which then has particular areas replaced with different elements. This particular example shows four elements composited on a background.

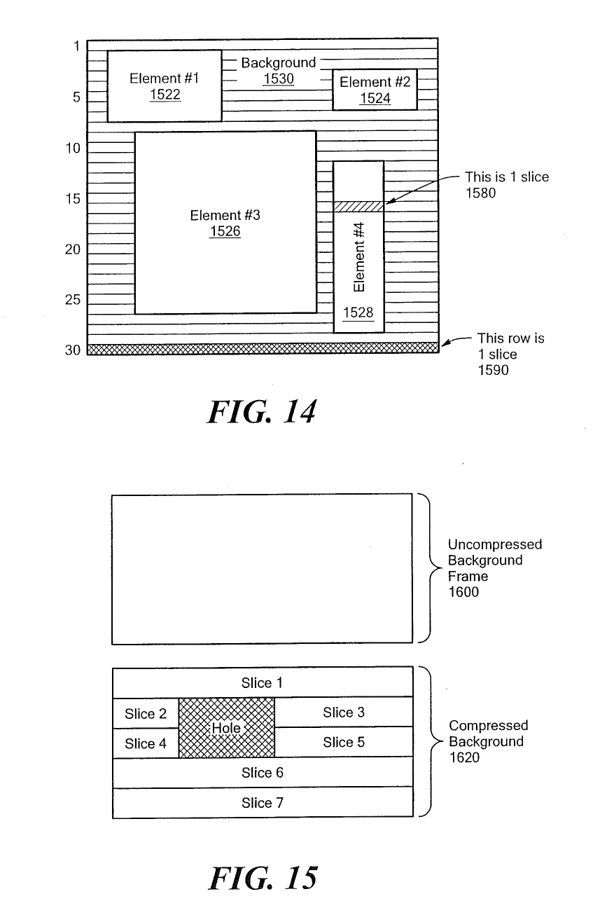

FIG. 14 shows a more detailed version of the screen illustrating the slices within the picture. The diagram depicts a picture consisting of 40 macroblocks per row and 30 rows per picture (non-restrictive, for illustration purposes only). However, it also shows the picture divided up into slices. The size of the slice can be a full row 1590 (shown as shaded) or a few macroblocks within a row 1580 (shown as rectangle with diagonal lines inside element #4 1528). The background 1530 has been broken into multiple regions with the slice size matching the width of each region. This can be better seen by looking at element #1 1522. Element #1 1522 has been defined to be twelve macroblocks wide. The slice size for this region for both the background 1530 and element #1 1522 is then defined to be that exact number of macroblocks. Element #1 1522 is then comprised of six slices, each slice containing 12 macroblocks. In a similar fashion, element #2 1524 consists of four slices of eight macroblocks per slice; element #3 1526 is eighteen slices of 23 macroblocks per slice; and element #4 1528 is seventeen slices of five macroblocks per slice. It is evident that the background 1530 and the elements can be defined to be composed of any number of slices which, in turn, can be any number of macroblocks. This gives full flexibility to arrange the picture and the elements in any fashion desired. The process of determining the slice content for each element along with the positioning of the elements within the video frame are determined by the virtual machine of FIG. 1 using the AVML file.

FIG. 15 shows the preparation of the background 1600 by the virtual machine in order for stitching to occur in the stitcher. The virtual machine gathers an uncompressed background based upon the AVML file and forwards the background to the element encoder. The virtual machine forwards the locations within the background where elements will be placed in the frame. As shown the background 1620 has been broken into a particular slice configuration by the virtual machine with a hole(s) that exactly aligns with where the element(s) will (are to) be placed prior to passing the background to the element encoder. The encoder compresses the background leaving a “hole” or “holes” where the element(s) will be placed. The encoder passes the compressed background to memory. The virtual machine then access the memory and retrieves each element for a scene and passes the encoded elements to the stitcher along with a list of the locations for each slice for each of the elements. The stitcher takes each of the slices and places the slices into the proper position.

This particular type of encoding is called “slice based encoding”. A slice based encoder/virtual machine is one that is aware of the desired slice structure of the output frame and performs its encoding appropriately. That is, the encoder knows the size of the slices and where they belong. It knows where to leave holes if that is required. By being aware of the desired output slice configuration, the virtual machine provides an output that is easily stitched.

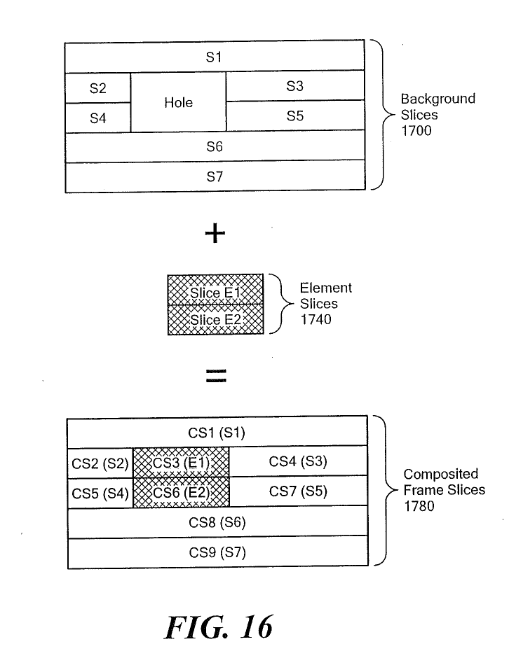

FIG. 16 shows the compositing process after the background element has been compressed. The background element 1700 has been compressed into seven slices with a hole where the element 1740 is to be placed. The composite image 1780 shows the result of the combination of the background element 1700 and element 1740. The composite video frame 1780 shows the slices that have been inserted in grey. Although this diagram depicts a single element composited onto a background, it is possible to composite any number of elements that will fit onto a user's display. Furthermore, the number of slices per row for the background or the element can be greater than what is shown. The slice start and slice end points of the background and elements must align.

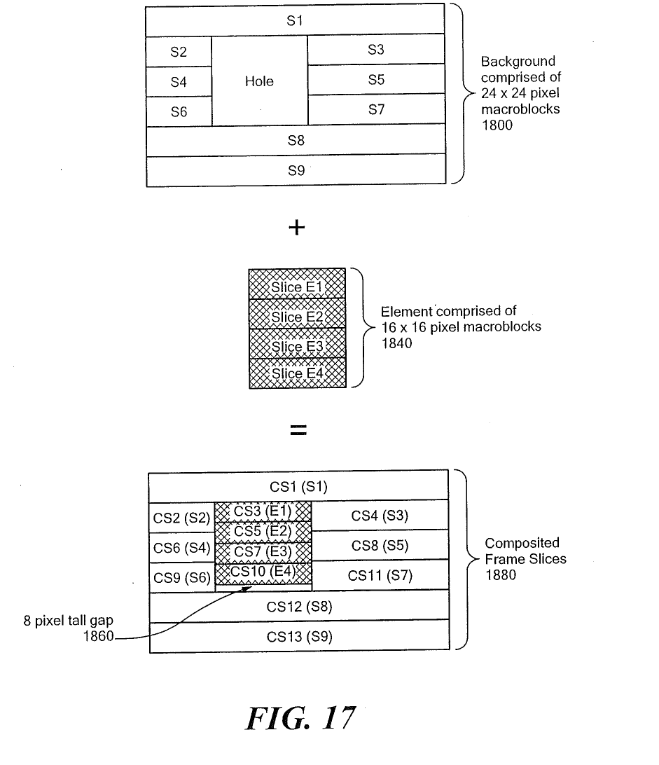

FIG. 17 is a diagram showing different macroblock sizes between the background element 1800 (24 pixels by 24 pixels) and the added video content element 1840 (16 pixels by 16 pixels). The composited video frame 1880 shows two cases. Horizontally, the pixels align as there are 24 pixels/block×4 blocks=96 pixels wide in the background 800 and 16 pixels/block*6 blocks=96 pixels wide for the video content element 1840. However, vertically, there is a difference. The background 1800 is 24 pixels/block*3 blocks=72 pixels tall. The element 1840 is 16 pixels/block*4 blocks=64 pixels tall. This leaves a vertical gap of 8 pixels 1860. The stitcher is aware of such differences and can extrapolate either the element or the background to fill the gap. It is also possible to leave a gap so that there is a dark or light border region. Any combination of macroblock sizes is acceptable even though this example uses macroblock sizes of 24×24 and 16×16. DCT based compression formats may rely on macroblocks of sizes other than 16×16 without deviating from the intended scope of the invention. Similarly, a DCT based compression format may also rely on variable sized macroblocks for temporal prediction without deviating from the intended scope of the invention Finally, frequency domain representations of content may also be achieved using other Fourier related transforms without deviating from the intended scope of the invention.

It is also possible for there to be an overlap in the composited video frame. Referring back to FIG. 17, the element 1840 consisted of four slices. Should this element actually be five slices, it would overlap with the background element 1800 in the composited video frame 1880. There are multiple ways to resolve this conflict with the easiest being to composite only four slices of the element and drop the fifth. It is also possible to composite the fifth slice into the background row, break the conflicting background row into slices and remove the background slice that conflicts with the fifth element slice (then possibly add a sixth element slice to fill any gap).

The possibility of different slice sizes requires the compositing function to perform a check of the incoming background and video elements to confirm they are proper. That is, make sure each one is complete (e.g., a full frame), there are no sizing conflicts, etc.

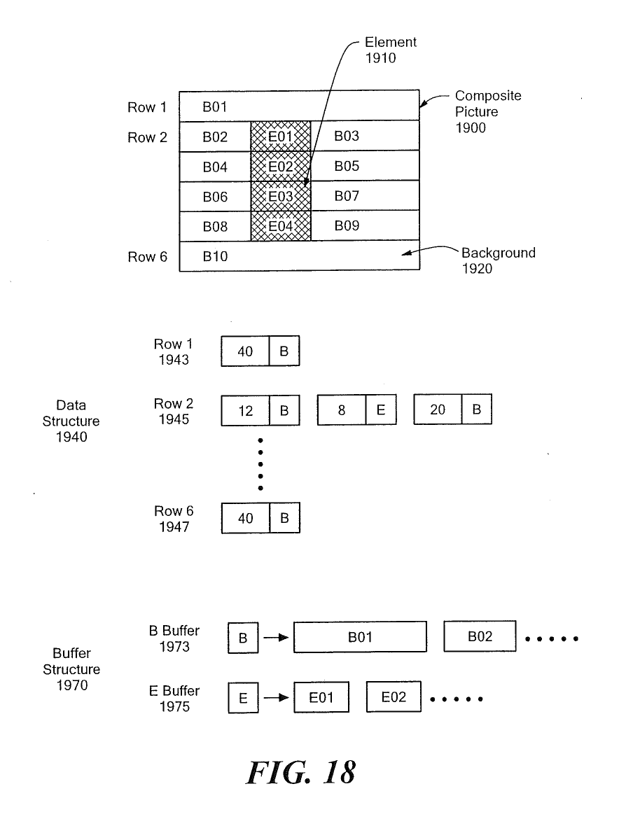

FIG. 18 is a diagram depicting elements of a frame. A simple composited picture 1900 is composed of an element 1910 and a background element 1920. To control the building of the video frame for the requested scene, the stitcher builds a data structure 1940 based upon the position information for each element as provided by the virtual machine. The data structure 1940 contains a linked list describing how many macroblocks and where the macroblocks are located. For example, the data row 1 1943 shows that the stitcher should take 40 macroblocks from buffer B, which is the buffer for the background. Data row 2 1945 should take 12 macroblocks from buffer B, then 8 macroblocks from buffer E (the buffer for element 1910), and then another 20 macroblocks from buffer B. This continues down to the last row 1947 wherein the stitcher uses the data structure to take 40 macroblocks from buffer B. The buffer structure 1970 has separate areas for each background or element. The B buffer 1973 contains all the information for stitching in B macroblocks. The E buffer 1975 has the information for stitching in E macroblocks.

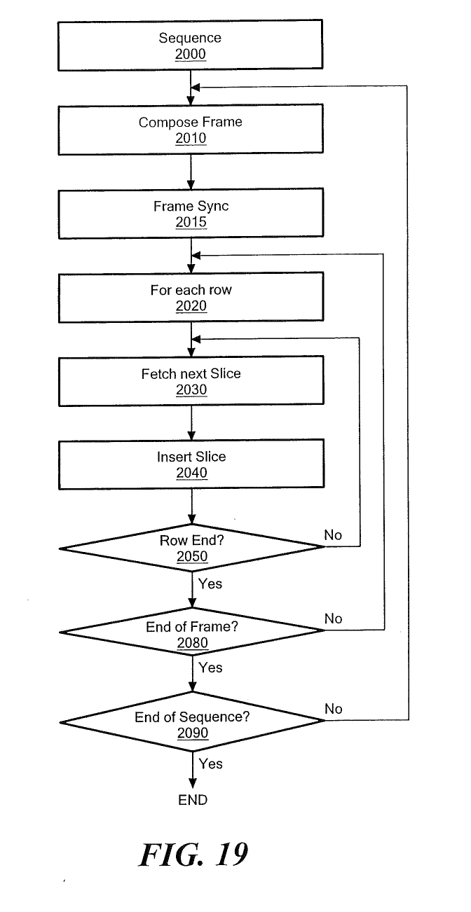

FIG. 19 is a flow chart depicting the process for building a picture from multiple encoded elements. The sequence 2000 begins by starting the video frame composition 2010. First the frames are synchronized 2015 and then each row 2020 is built up by grabbing the appropriate slice 2030. The slice is then inserted 2040 and the system checks to see if it is the end of the row 2050. If not, the process goes back to “fetch next slice” block 2030 until the end of row 2050 is reached. Once the row is complete, the system checks to see if it is the end of frame 2080. If not, the process goes back to the “for each row” 2020 block. Once the frame is complete, the system checks if it is the end of the sequence 2090 for the scene. If not, it goes back to the “compose frame” 2010 step. If it is, the frame or sequence of video frames for the scene is complete 2090. If not, it repeats the frame building process. If the end of sequence 2090 has been reached, the scene is complete and the process ends or it can start the construction of another frame.

The performance of the stitcher can be improved (build frames faster with less processor power) by providing the stitcher advance information on the frame format. For example, the virtual machine may provide the stitcher with the start location and size of the areas in the frame to be inserted. Alternatively, the information could be the start location for each slice and the stitcher could then figure out the size (the difference between the two start locations). This information could be provided externally by the virtual machine or the virtual machine could incorporate the information into each element. For instance, part of the slice header could be used to carry this information. The stitcher can use this foreknowledge of the frame structure to begin compositing the elements together well before they are required.

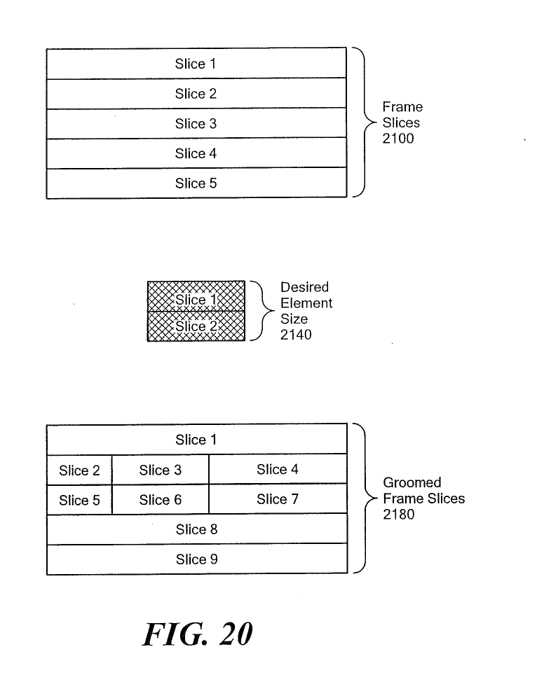

FIG. 20 shows a further improvement on the system. As explained above in the groomer section, the graphical video elements can be groomed thereby providing stitchable elements that are already compressed and do not need to be decoded in order to be stitched together. In FIG. 20, a frame has a number of encoded slices 2100. Each slice is a full row (this is used as an example only; the rows could consist of multiple slices prior to grooming). The virtual machine in combination with the AVML file determines that there should be an element 2140 of a particular size placed in a particular location within the composited video frame. The groomer processes the incoming background 2100 and converts the full-row encoded slices to smaller slices that match the areas around and in the desired element 2140 location. The resulting groomed video frame 2180 has a slice configuration that matches the desired element 2140. The stitcher then constructs the stream by selecting all the slices except #3 and #6 from the groomed frame 2180. Instead of those slices, the stitcher grabs the element 2140 slices and uses those in its place. In this manner, the background never leaves the compressed domain and the system is still able to composite the element 2140 into the frame.

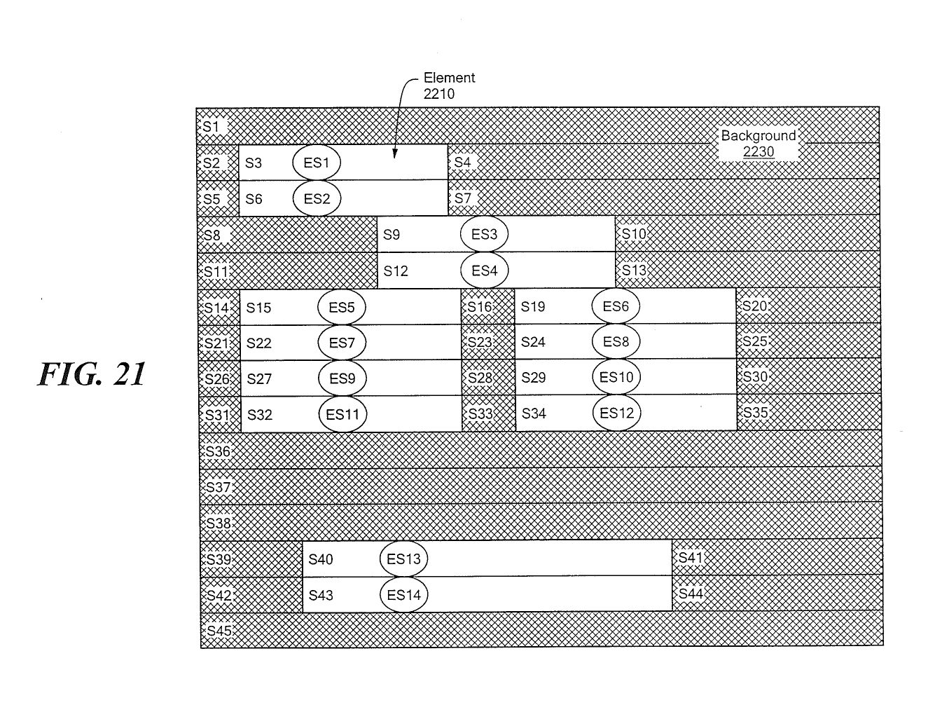

FIG. 21 shows the flexibility available to define the element to be composited. Elements can be of different shapes and sizes. The elements need not reside contiguously and in fact a single element can be formed from multiple images separated by the background. This figure shows a background element 2230 (areas colored grey) that has had a single element 2210 (areas colored white) composited on it. In this diagram, the composited element 2210 has areas that are shifted, are different sizes, and even where there are multiple parts of the element on a single row. The stitcher can perform this stitching just as if there were multiple elements used to create the display. The slices for the frame are labeled contiguously S1-S45. These include the slice locations where the element will be placed. The element also has its slice numbering from ES1-ES14. The element slices can be placed in the background where desired even though they are pulled from a single element file.

The source for the element slices can be any one of a number of options. It can come from a real-time encoded source. It can be a complex slice that is built from separate slices, one having a background and the other having text. It can be a pre-encoded element that is fetched from a cache. These examples are for illustrative purposes only and are not intended to limit the options for element sources.

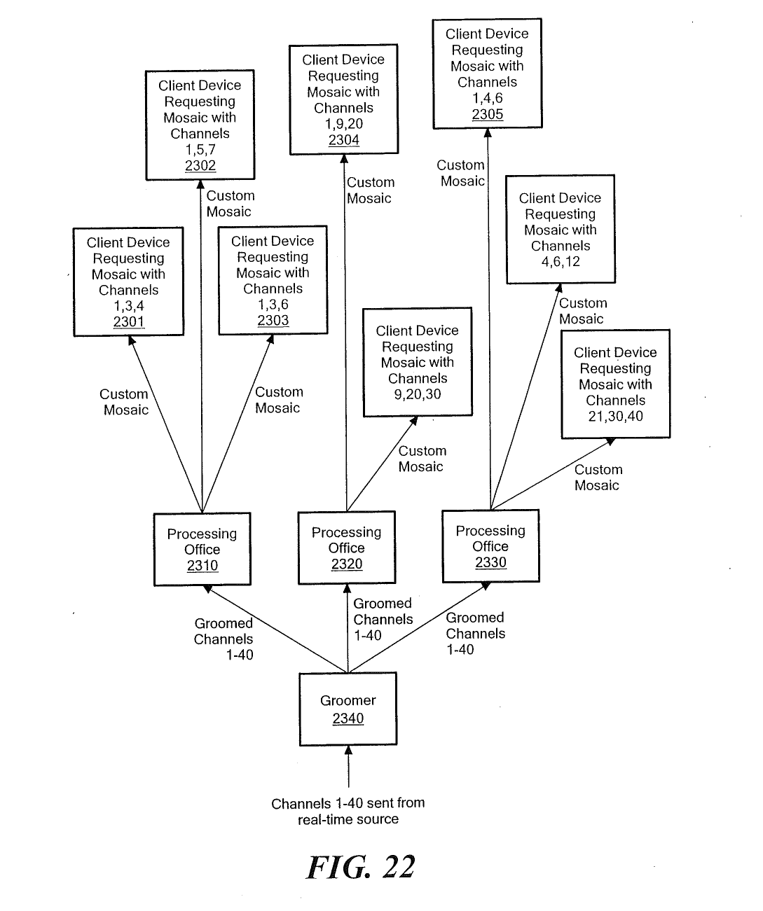

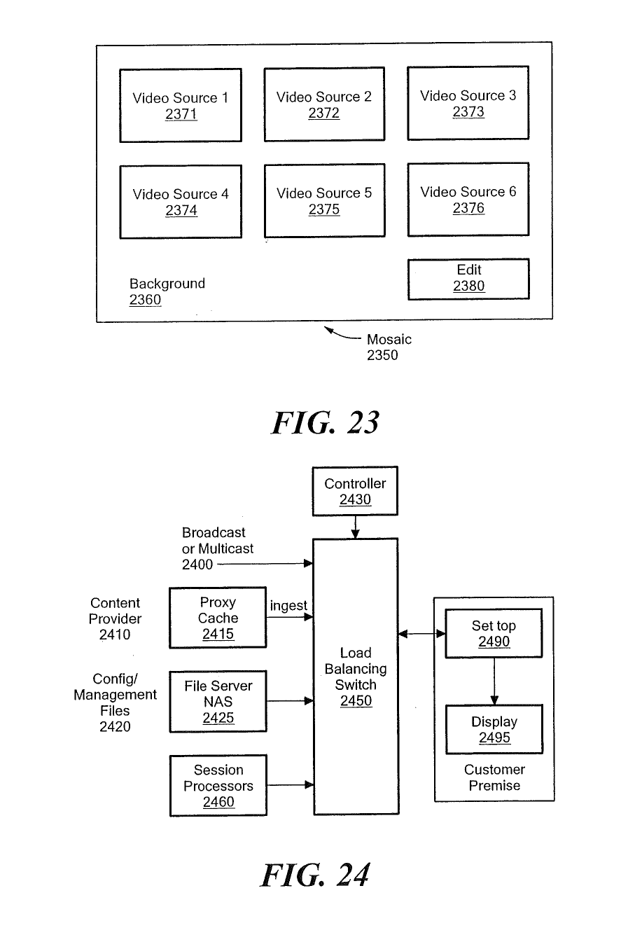

FIG. 22 shows an embodiment using a groomer 2340 for grooming linear broadcast content. The content is received by the groomer 2340 in real-time. Each channel is groomed by the groomer 2340 so that the content can be easily stitched together. The groomer 2340 of FIG. 22 may include a plurality of groomer modules for grooming all of the linear broadcast channels. The groomed channels may then be multicast to one or more processing offices 2310, 2320, 2330 and one or more virtual machines within each of the processing offices for use in applications. As shown, client devices request an application for receipt of a mosaic 2350 of linear broadcast sources and/or other groomed content that are selected by the client. A mosaic 2350 is a scene that includes a background frame 2360 that allows for viewing of a plurality of sources 2371-2376 simultaneously as shown in FIG. 23. For example, if there are multiple sporting events that a user wishes to watch, the user can request each of the channels carrying the sporting events for simultaneous viewing within the mosaic. The user can even select an MPEG object (edit) 2380 and then edit the desired content sources to be displayed. For example, the groomed content can be selected from linear/live broadcasts and also from other video content (i.e. movies, pre-recorded content etc.). A mosaic may even include both user selected material and material provided by the processing office/session processor, such as, advertisements. As shown in FIG. 22, client devices 2301-2305 each request a mosaic that includes channel 1. Thus, the multicast groomed content for channel 1 is used by different virtual machines and different processing offices in the construction of personalized mosaics.

When a client device sends a request for a mosaic application, the processing office associated with the client device assigns a processor/virtual machine for the client device for the requested mosaic application. The assigned virtual machine constructs the personalized mosaic by compositing the groomed content from the desired channels using a stitcher. The virtual machine sends the client device an MPEG stream that has a mosaic of the channels that the client has requested. Thus, by grooming the content first so that the content can be stitched together, the virtual machines that create the mosaics do not need to first decode the desired channels, render the channels within the background as a bitmap and then encode the bitmap.

An application, such as a mosaic, can be requested either directly through a client device or indirectly through another device, such as a PC, for display of the application on a display associated with the client device. The user could log into a website associated with the processing office by providing information about the user's account. The server associated with the processing office would provide the user with a selection screen for selecting an application. If the user selected a mosaic application, the server would allow the user to select the content that the user wishes to view within the mosaic. In response to the selected content for the mosaic and using the user's account information, the processing office server would direct the request to a session processor and establish an interactive session with the client device of the user. The session processor would then be informed by the processing office server of the desired application. The session processor would retrieve the desired application, the mosaic application in this example, and would obtain the required MPEG objects. The processing office server would then inform the session processor of the requested video content and the session processor would operate in conjunction with the stitcher to construct the mosaic and provide the mosaic as an MPEG video stream to the client device. Thus, the processing office server may include scripts or application for performing the functions of the client device in setting up the interactive session, requesting the application, and selecting content for display. While the mosaic elements may be predetermined by the application, they may also be user configurable resulting in a personalized mosaic.

FIG. 24 is a diagram of an IP based content delivery system. In this system, content may come from a broadcast source 2400, a proxy cache 2415 fed by a content provider 2410, Network Attached Storage (NAS) 2425 containing configuration and management files 2420, or other sources not shown. For example, the NAS may include asset metadata that provides information about the location of content. This content could be available through a load balancing switch 2460. BladeSession processors/virtual machines 2460 can perform different processing functions on the content to prepare it for delivery. Content is requested by the user via a client device such as a set top box 2490. This request is processed by the controller 2430 which then configures the resources and path to provide this content. The client device 2490 receives the content and presents it on the user's display 2495.

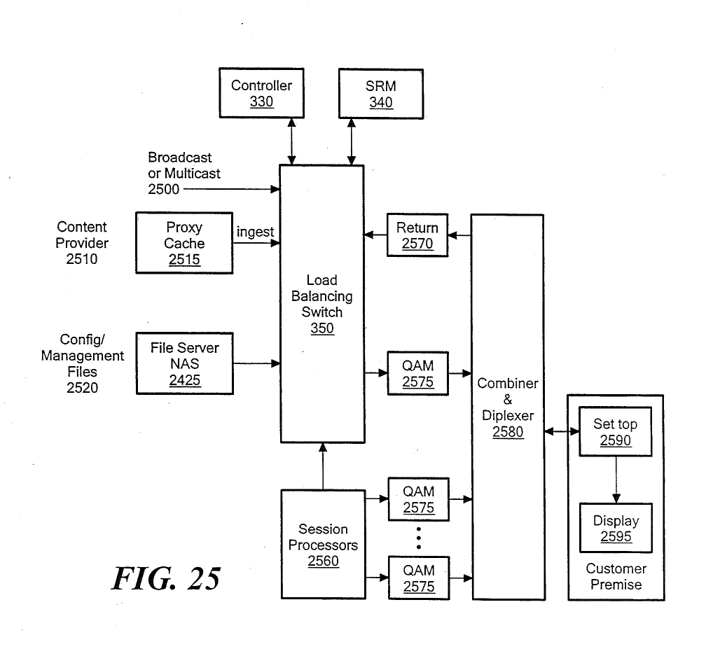

FIG. 25 provides a diagram of a cable based content delivery system. Many of the components are the same: a controller 2530, broadcast source 2500, a content provider 2510 providing their content via a proxy cache 2515, configuration and management files 2520 via a file server NAS 2525, session processors 2560, load balancing switch 2550, a client device, such as a set top box 2590, and a display 2595. However, there are also a number of additional pieces of equipment required due to the different physical medium. In this case the added resources include: QAM modulators 2575, a return path receiver 2570, a combiner and diplexer 2580, and a Session and Resource Manager (SRM) 2540. QAM upconverter 2575 are required to transmit data (content) downstream to the user. These modulators convert the data into a form that can be carried across the coax that goes to the user. Correspondingly, the return path receiver 2570 also is used to demodulate the data that comes up the cable from the set top 2590. The combiner and diplexer 2580 is a passive device that combines the downstream QAM channels and splits out the upstream return channel. The SRM is the entity that controls how the QAM modulators are configured and assigned and how the streams are routed to the client device.

These additional resources add cost to the system. As a result, the desire is to minimize the number of additional resources that are required to deliver a level of performance to the user that mimics a non-blocking system such as an IP network. Since there is not a one-to-one correspondence between the cable network resources and the users on the network, the resources must be shared. Shared resources must be managed so they can be assigned when a user requires a resource and then freed when the user is finished utilizing that resource. Proper management of these resources is critical to the operator because without it, the resources could be unavailable when needed most. Should this occur, the user either receives a “please wait” message or, in the worst case, a “service unavailable” message.

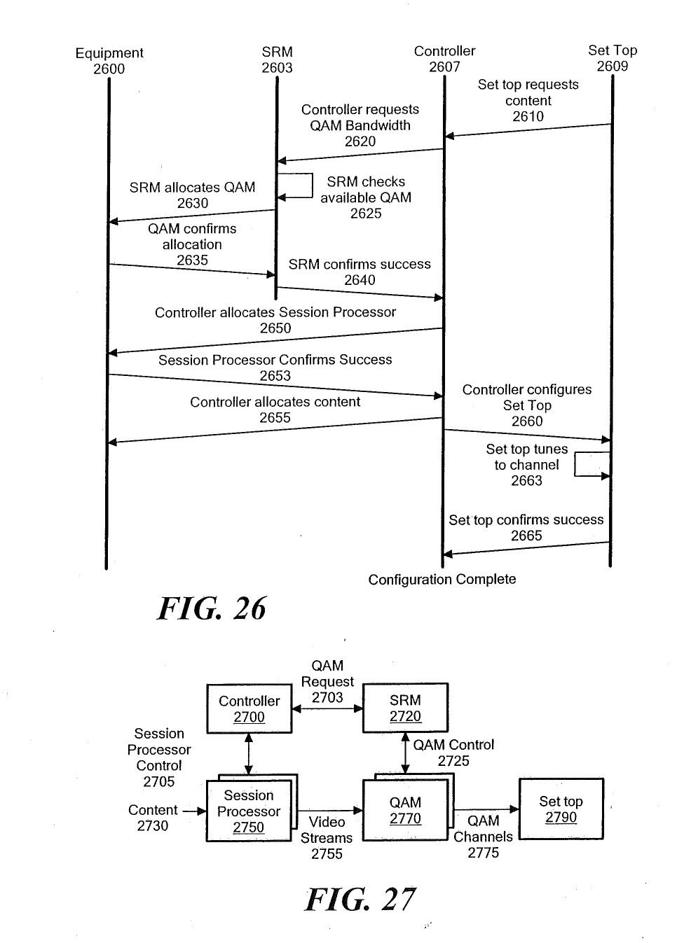

FIG. 26 is a diagram showing the steps required to configure a new interactive session based on input from a user. This diagram depicts only those items that must be allocated or managed or used to do the allocation or management. A typical request would follow the steps listed below:
(1) The Set Top 2609 requests content 2610 from the Controller 2607
(2) The Controller 2607 requests QAM bandwidth 2620 from the SRM 2603
(3) The SRM 2603 checks QAM availability 2625
(4) The SRM 2603 allocates the QAM modulator 2630
(5) The QAM modulator returns confirmation 2635
(6) The SRM 2603 confirms QAM allocation success 2640 to the Controller
(7) The Controller 407 allocates the Session processor 2650
(8) The Session processor confirms allocation success 2653
(9) The Controller 2607 allocates the content 2655
(10) The Controller 2607 configures 2660 the Set Top 2609. This includes:
   a. Frequency to tune
   b. Programs to acquire or alternatively PIDs to decode
   c. IP port to connect to the Session processor for keystroke capture
(11) The Set Top 2609 tunes to the channel 2663
(12) The Set Top 2609 confirms success 2665 to the Controller 2607

The Controller 2607 allocates the resources based on a request for service from a set top box 2609. It frees these resources when the set top or server sends an “end of session”. While the controller 2607 can react quickly with minimal delay, the SRM 2603 can only allocate a set number of QAM sessions per second i.e. 200. Demand that exceeds this rate results in unacceptable delays for the user. For example, if 500 requests come in at the same time, the last user would have to wait 5 seconds before their request was granted. It is also possible that rather than the request being granted, an error message could be displayed such as “service unavailable”.

While the example above describes the request and response sequence for an AVDN session over a cable TV network, the example below describes a similar sequence over an IPTV network. Note that the sequence in itself is not a claim, but rather illustrates how AVDN would work over an IPTV network.
(1) Client device requests content from the Controller via a Session Manager (i.e. controller proxy).
(2) Session Manager forwards request to Controller.
(3) Controller responds with the requested content via Session Manager (i.e. client proxy).
(4) Session Manager opens a unicast session and forwards Controller response to client over unicast IP session,
(5) Client device acquires Controller response sent over unicast IP session.
(6) Session manager may simultaneously narrowcast response over multicast IP session to share with other clients on node group that request same content simultaneously as a bandwidth usage optimization technique.

FIG. 27 is a simplified system diagram used to break out each area for performance improvement. This diagram focuses only on the data and equipment that will be managed and removes all other non-managed items. Therefore, the switch, return path, combiner, etc. are removed for the sake of clarity. This diagram will be used to step through each item, working from the end user back to the content origination.

A first issue is the assignment of QAMs 2770 and QAM channels 2775 by the SRM 2720. In particular, the resources must be managed to prevent SRM overload, that is, eliminating the delay the user would see when requests to the SRM 2720 exceed its sessions per second rate.

To prevent SRM “overload”, “time based modeling” may be used. For time based modeling, the Controller 2700 monitors the history of past transactions, in particular, high load periods. By using this previous history, the Controller 2700 can predict when a high load period may occur, for example, at the top of an hour. The Controller 2700 uses this knowledge to pre-allocate resources before the period comes. That is, it uses predictive algorithms to determine future resource requirements. As an example, if the Controller 2700 thinks 475 users are going to join at a particular time, it can start allocating those resources 5 seconds early so that when the load hits, the resources have already been allocated and no user sees a delay.

Secondly, the resources could be pre-allocated based on input from an operator. Should the operator know a major event is coming, e.g., a pay per view sporting event, he may want to pre-allocate resources in anticipation. In both cases, the SRM 2720 releases unused QAM 2770 resources when not in use and after the event.

Thirdly, QAMs 2770 can be allocated based on a “rate of change” which is independent of previous history. For example, if the controller 2700 recognizes a sudden spike in traffic, it can then request more QAM bandwidth than needed in order to avoid the QAM allocation step when adding additional sessions. An example of a sudden, unexpected spike might be a button as part of the program that indicates a prize could be won if the user selects this button.

Currently, there is one request to the SRM 2720 for each session to be added. Instead the controller 2700 could request the whole QAM 2770 or a large part of a single QAM's bandwidth and allow this invention to handle the data within that QAM channel 2775. Since one aspect of this system is the ability to create a channel that is only 1, 2, or 3 Mb/sec, this could reduce the number of requests to the SRM 2720 by replacing up to 27 requests with a single request.

The user will also experience a delay when they request different content even if they are already in an active session. Currently, if a set top 2790 is in an active session and requests a new set of content 2730, the Controller 2700 has to tell the SRM 2720 to de-allocate the QAM 2770, then the Controller 2700 must de-allocate the session processor 2750 and the content 2730, and then request another QAM 2770 from the SRM 2720 and then allocate a different session processor 2750 and content 2730. Instead, the controller 2700 can change the video stream 2755 feeding the QAM modulator 2770 thereby leaving the previously established path intact. There are a couple of ways to accomplish the change. First, since the QAM Modulators 2770 are on a network so the controller 2700 can merely change the session processor 2750 driving the QAM 2770. Second, the controller 2700 can leave the session processor 2750 to set top 2790 connection intact but change the content 2730 feeding the session processor 2750, e.g., “CNN Headline News” to “CNN World Now”. Both of these methods eliminate the QAM initialization and Set Top tuning delays.

Thus, resources are intelligently managed to minimize the amount of equipment required to provide these interactive services. In particular, the Controller can manipulate the video streams 2755 feeding the QAM 2770. By profiling these streams 2755, the Controller 2700 can maximize the channel usage within a QAM 2770. That is, it can maximize the number of programs in each QAM channel 2775 reducing wasted bandwidth and the required number of QAMs 2770. There are three primary means to profile streams: formulaic, pre-profiling, and live feedback.

The first profiling method, formulaic, consists of adding up the bit rates of the various video streams used to fill a QAM channel 2775. In particular, there may be many video elements that are used to create a single video stream 2755. The maximum bit rate of each element can be added together to obtain an aggregate bit rate for the video stream 2755. By monitoring the bit rates of all video streams 2755, the Controller 2700 can create a combination of video streams 2755 that most efficiently uses a QAM channel 2775. For example, if there were four video streams 2755: two that were 16 Mb/sec and two that were 20 Mb/sec then the controller could best fill a 38.8 Mb/sec QAM channel 2775 by allocating one of each bit rate per channel. This would then require two QAM channels 2775 to deliver the video. However, without the formulaic profiling, the result could end up as 3 QAM channels 2775 as perhaps the two 16 Mb/sec video streams 2755 are combined into a single 38.8 Mb/sec QAM channel 2775 and then each 20 Mb/sec video stream 2755 must have its own 38.8 Mb/sec QAM channel 2775.

A second method is pre-profiling. In this method, a profile for the content 2730 is either received or generated internally. The profile information can be provided in metadata with the stream or in a separate file. The profiling information can be generated from the entire video or from a representative sample. The controller 2700 is then aware of the bit rate at various times in the stream and can use this information to effectively combine video streams 2755 together. For example, if two video streams 2755 both had a peak rate of 20 Mb/sec, they would need to be allocated to different 38.8 Mb/sec QAM channels 2775 if they were allocated bandwidth based on their peaks. However, if the controller knew that the nominal bit rate was 14 Mb/sec and knew their respective profiles so there were no simultaneous peaks, the controller 2700 could then combine the streams 2755 into a single 38.8 Mb/sec QAM channel 2775. The particular QAM bit rate is used for the above examples only and should not be construed as a limitation.

A third method for profiling is via feedback provided by the system. The system can inform the controller 2700 of the current bit rate for all video elements used to build streams and the aggregate bit rate of the stream after it has been built. Furthermore, it can inform the controller 2700 of bit rates of stored elements prior to their use. Using this information, the controller 2700 can combine video streams 2755 in the most efficient manner to fill a QAM channel 2775.

It should be noted that it is also acceptable to use any or all of the three profiling methods in combination. That is, there is no restriction that they must be used independently.

The system can also address the usage of the resources themselves. For example, if a session processor 2750 can support 100 users and currently there are 350 users that are active, it requires four session processors. However, when the demand goes down to say 80 users, it would make sense to reallocate those resources to a single session processor 2750, thereby conserving the remaining resources of three session processors. This is also useful in failure situations. Should a resource fail, the invention can reassign sessions to other resources that are available. In this way, disruption to the user is minimized.

The system can also repurpose functions depending on the expected usage. The session processors 2750 can implement a number of different functions, for example, process video, process audio, etc. Since the controller 2700 has a history of usage, it can adjust the functions on the session processors 2700 to meet expected demand. For example, if in the early afternoons there is typically a high demand for music, the controller 2700 can reassign additional session processors 2750 to process music in anticipation of the demand. Correspondingly, if in the early evening there is a high demand for news, the controller 2700 anticipates the demand and reassigns the session processors 2750 accordingly. The flexibility and anticipation of the system allows it to provide the optimum user experience with the minimum amount of equipment. That is, no equipment is idle because it only has a single purpose and that purpose is not required.

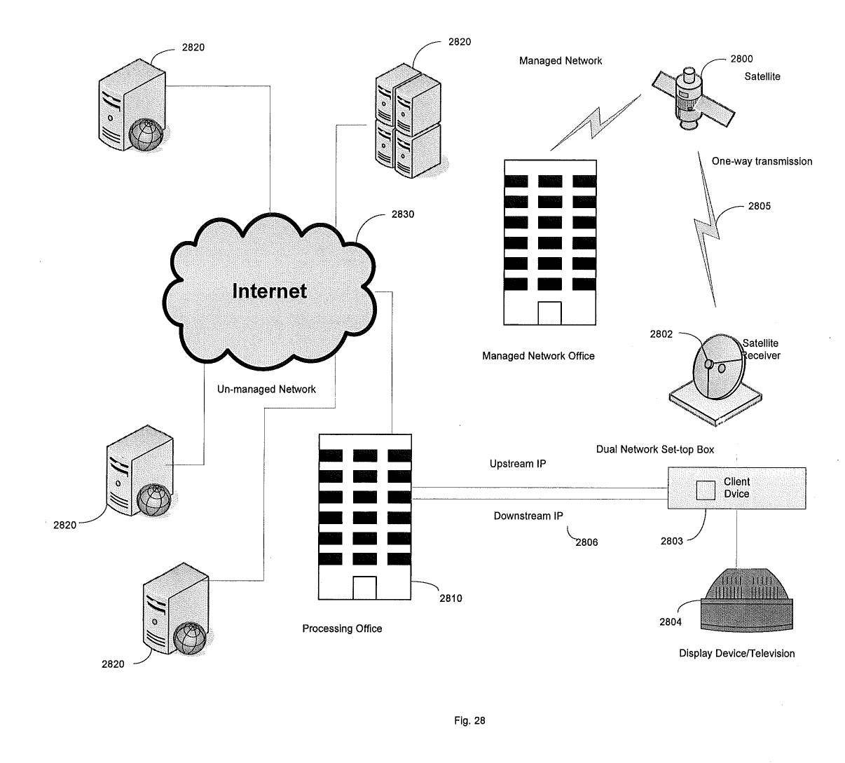

FIG. 28 shows a managed broadcast content satellite network that can provide interactive content to subscribers through an unmanaged IP network. A managed network is a communications network wherein the content that is transmitted is determined solely by the service provider and not by the end-user. Thus, the service provider has administrative control over the presented content. This definition is independent of the physical interconnections and is a logical association. In fact, both networks may operate over the same physical link. In a managed network, a user may select a channel from a plurality of channels broadcast by the service provider, but the overall content is determined by the service provider and the user can not access any other content outside of the network. A managed network is a closed network. An unmanaged network allows a user to request and receive content from a party other than the service provider. For example, the Internet is an unmanaged network, wherein a user that is in communication with the Internet can select to receive content from one of a plurality of sources and is not limited by content that is provided by an Internet Service Provider (ISP). Managed networks may be satellite networks, cable networks and IP television networks for example.

As shown in FIG. 28, broadcast content is uploaded to a satellite 2800 by a managed network office 2801 on one or more designated channels. A channel may be a separate frequency or a channel may be an association of data that is related together by a delimiter (i.e. header information). The receiving satellite 2800 retransmits the broadcast content including a plurality of channels that can be selected by a subscriber. A satellite receiver 2802 at the subscriber's home receives the transmission and forwards the transmission to a client device 2803, such as a set-top box. The client device decodes the satellite transmission and provides the selected channel for view on the subscriber's display device 2804.

Within the broadcast content of the broadcast transmission are one or more triggers. A trigger is a designator of possible interactive content. For example, a trigger may accompany an advertisement that is either inserted within the broadcast content or is part of a frame that contains broadcast content. Triggers may be associated with one or more video frames and can be embedded within the header for one or more video frames, may be part of an analog transmission signal, or be part of the digital data depending upon the medium on which the broadcast content is transmitted. In response to the advertisement, a user may use a user input device (not shown), such as a remote control, to request interactive content related to the advertisement. In other embodiments, the trigger may automatically cause an interactive session to begin and the network for receiving content to be switched between a managed and unmanaged network. In response, the client device 2803 switches between receiving the broadcast content 2805 from the satellite network 2800 and receiving and transmitting content via an unmanaged network 2806, such as the Internet. The client device may include a single box that receives and decodes transmissions from the managed network and also includes two-way communication with an unmanaged network. Thus, the client device may include two separate receivers and at least one transmitter. The client device may have a single shared processor for both the managed and unmanaged networks or there may be separate processors within the client device. A software module controls the switching between the two networks

As such, the software module is a central component that communicates with both networks. In alternative embodiments, separate client decoding boxes may be employed for the managed and unmanaged networks wherein the two boxes include a communication channel. For example, the two boxes may communicate via IP or UDP protocols wherein a first box may send an interrupt to the second box or send an output suppression signal. The boxes may be provided with discovery agents that recognize when ports are connected together and all the two boxes to negotiate connection. The communication channel allows the two boxes to communicate so that the output of the boxes may be switched. Thus, each box operates using a common communication protocol that allows for the box to send commands and control at least the output port of the other box. It should be recognized that the description of the present embodiment with respect to satellite-based systems is for exemplary purposes only and that the description may be readily applied to embodiments that include both managed and unmanaged networks.

When the user requests the interactive content by sending a transmission to the client device 2802, the client device 2802 extracts the trigger and transmits the trigger through the unmanaged network to a processing office 2810. The processing office 2810 either looks-up the associated internet address for the interactive content in a look-up table or extracts the internet address from the received transmission from the client device. The processing office forwards the request to the appropriate content server 2820 through the Internet 2830. The interactive content is returned to the processing office 2810 and the processing office 2810 processes the interactive content into a format that is compatible with the client device 2803. For example, the processing office 2810 may encode transcoding by scaling a stitching the content as an MPEG video stream as discussed above. The video stream can then be transmitted from the processing office 2810 to the client device 2803 over the unmanaged network 2806 as a series of IP packets. In such an embodiment, the client device 2802 includes a satellite decoder and also a port for sending and receiving communications via an unmanaged IP network. When the requested interactive content is received by the client device 2803, the client device can switch between outputting the satellite broadcast channel and outputting the interactive content received via the unmanaged network. In certain embodiments, the audio content may continue to be received by the satellite transmission and only the video is switched between the satellite communications channel and the IP communications channel. The audio channel from the satellite transmission will be mixed with the video received through the unmanaged IP network. In other embodiments, both the audio and video signal are switched between the managed and unmanaged networks.

It should be recognized by one of ordinary skill in the art that the triggers need not be limited to advertisements, but may relate to other forms of interactive content. For example, a broadcast transmission may include a trigger during a sporting event that allows a user to retrieve interactive content regarding statistics for a team playing the sporting event.

In some embodiments, when a trigger is identified within the transmission, an interactive session is automatically established and interactive content from two or more sources is merged together as explained above. The interactive content is then provided to the client device through the communication network and is decoded. Thus, the user does not need to provide input to the client device before an interactive session is established.

In certain embodiments, the client device may receive content from both the managed and unmanaged network and may replace information from one with the other. For example, broadcast content may be transmitted over the managed network with identifiable insertion points (e.g. time codes, header information etc.) for advertisements. The broadcast content may contain an advertisement at the insertion point and the client device can replace the broadcast advertisement with an advertisement transmitted over the managed network wherein the client device switches between the managed and unmanaged networks for the length of the advertisement.

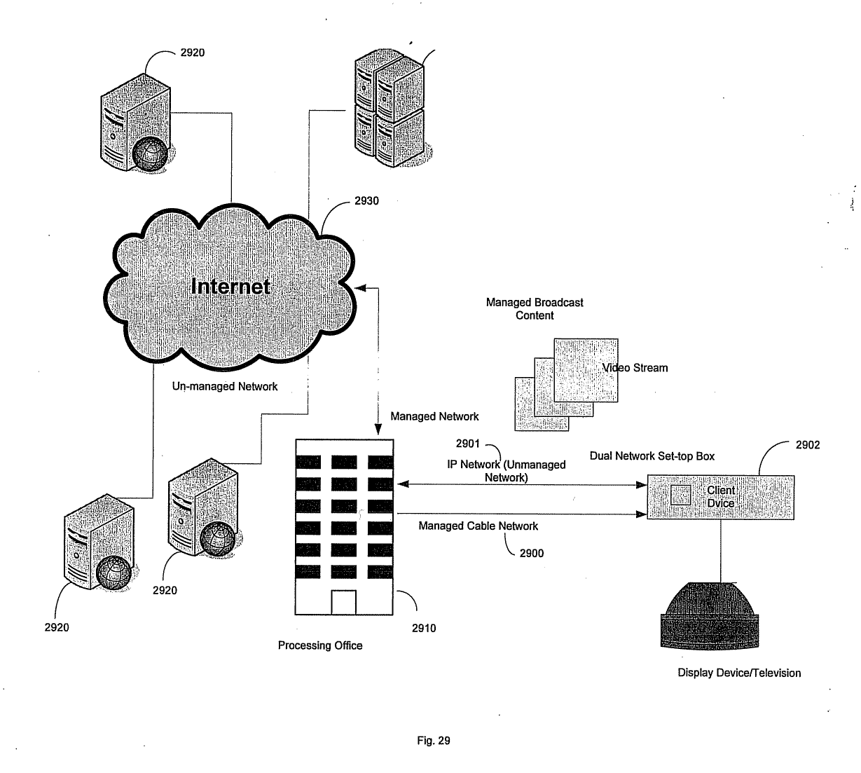

FIG. 29 shows another environment where a client device 2902 receives broadcast content through a managed network 2900 and interactive content may be requested and is provided through an unmanaged network 2901. In this embodiment, a processing office 2910, delivers broadcast content via a cable system 2900. The broadcast content being selectable by a user based upon interaction with a set-top box 2902 that provides for selection of one of a plurality of broadcasts programs. One or more of the broadcast programs include a trigger within the broadcast (i.e. within a header associated with the broadcast, within the digital data, or within the analog signal). When the client device 2910 receives the broadcast signal and outputs the selected broadcast content, a program running on the client device 2902 identifies the trigger and stores the trigger in a temporary buffer. If the trigger changes as the broadcast program progresses, the client device will update the buffer. For example, the trigger may have a temporal expiration. The trigger may be associated with a number of frames of video from the video content and therefore, is temporally limited. In other embodiments, the trigger may be sent to and stored at the processing office. In such an embodiment, only one copy of the triggers for each broadcast channel need be stored.

A user may request interactive content using a user input device (i.e. a remote control) that communicates with the client device 2902. For, example, the client device may be a set-top box, a media gateway, or a video gaming system. When the client device receives the request, the client device identifies the trigger associated with the request by accessing the temporary buffer holding the trigger. The trigger may simply be an identifier that is passed upstream to the processing office 2910 through an unmanaged network 2901 or the trigger may contain routing information (i.e. an IP address). The client device 2902 transmits the trigger along with an identifier of the client device to the processing office. The processing office 2910 receives the request for interactive content and either uses the trigger identifier to access a look-up table that contains a listing of IP addresses or the processing office makes a request through the internet 2930 to the IP address for the interactive content, which is located at a content server 2920. The unmanaged network coupled between the client device and the processing office may be considered part of the Internet. The interactive content is sent to the processing office from either a server on the Internet or from the content server. The processing office processes the interactive content into a format that is compatible with the client device. The interactive content may be converted to an MPEG video stream and sent from the processing office down stream to the client device as a plurality of IP packets. The MPEG video stream is MPEG compliant and readily decodable by a standard MPEG decoder. Interactive content may originate from one or more sources and the content may be reformatted, scaled, and stitched together to form a series of video frames. The interactive content may include static elements, dynamic element and both static and dynamic elements in one or more video frames composing the interactive content. When the client device 2902 receives the interactive content, the client device switches from the broadcast content being received from the managed network and switches to receiving the interactive content from the unmanaged network. The client device 2902 decodes the received interactive content and the user may interact with the interactive content wherein the processing office receives requests for changes in the content from the client device. In response to the requests, the processing office retrieves the content, encodes the content as a video stream and sends the content to the client device via the unmanaged network.

In other embodiments, the trigger causing a request for an interactive session may occur external to the broadcast content. For example, the request may result in response to a user's interaction with an input device, such as a remote control. The signal produced by the remote control is sent to the client device and the client device responds by switching between receiving broadcast content over the managed network to making a request for an interactive session over the unmanaged network. The request for the interactive session is transmitted over a communication network to a processing office. The processing office assigns a processor and a connection is negotiated between the processor and the client device. The client device might be a set-top box, media gateway, consumer electronic device or other device that can transmit through a network, such as the Internet, remote control signals and receive and decode a standard MPEG encoded video stream. The processor at the processing office gathers the interactive content from two or more sources. For example, an AVML template may be used that includes MPEG objects and MPEG video content may be retrieved from a locally stored source or a source that is reachable through a network connection. For example, the network may be an IP network and the MPEG video content may be stored on a server within the Internet. The assigned processor causes the interactive content to be stitched together. The stitched content is then transmitted via the network connection to the client device, which decodes and presents the decoded content to a display device.

As an example, a television that includes an internal or external QAM tuner receives a broadcast cable television signal. The broadcast cable television signal includes one or more triggers or a user uses an input device to create a request signal. The television either parses the trigger during decoding of the broadcast cable television signal or receives the request from the input device and as a result causes a signal to be generated to an IP device that is coupled to the Internet (unmanaged network). The television suppresses output of the broadcast cable television signal to the display. The IP device may be a separate external box or internal to the television that responds to the trigger or request signal by requesting an interactive session with a processing office located over an Internet connection. A processor is assigned by the processing office and a connection is negotiated between the IP device and the assigned processor. The assigned processor generates the interactive content from two or more sources and produces an MPEG elementary stream. The MPEG elementary stream is transmitted to the IP device. The IP device then outputs the MPEG elementary stream to the television that decodes and presents the interactive content to the television display. In response to further interaction by the user with an input device updates to the elementary stream can be achieved by the assigned processor. When the user decides to return to the broadcast television content or the interactive content finishes, the television, suspends suppression of the broadcast television content signal and the television decodes and presents the broadcast television signal to the display. Thus, the system switches between a managed network and an unmanaged network as the result of a trigger or request signal wherein interactive content signal is created from two or more sources at a location remote from the television.

It should be recognized by one of ordinary skill in the art that the foregoing embodiments are not restricted to satellite and cable television systems and the embodiments may be equally applicable to IPTV networks, such as IPTV networks that use the telephone system. In such an embodiment, the IPTV network would be the managed network and the unmanaged network would be a connection to the Internet (e.g. a DSL modem, wireless Internet network connection; Ethernet Internet connection).

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

What is claimed is:

1. A method for providing interactive content over an unmanaged network to a display device associated with a user, the display device receiving broadcast video content over a managed network, the method comprising:
receiving from a network connected client device a request for interactive content over the unmanaged network;
sending a first encoded data stream having interactive content to the network connected client device over the unmanaged network;
switching between receiving a broadcast content signal from the managed network and receiving the first encoded data stream having interactive content from the unmanaged network; and
outputting the interactive content for display on the display device of the user.

2. The method according to claim 1, wherein the broadcast content signal contains a plurality of broadcast programs.

3. The method according to claim 2, wherein the networked client device selectively outputs one of the broadcast programs.

4. The method according to claim 1 wherein the managed network has a one-way transmission path.

5. The method according to claim 1 wherein the managed network is a satellite network.

6. The method according to claim 1 wherein the managed network is an IP television network.

7. The method according to claim 1 wherein the managed network is a cable television network.

8. The method according to claim 1, wherein the unmanaged network and the managed networks operates over a single communications link.

9. The method according to claim 1 wherein the interactive content identifier is a trigger.

10. The method according to claim 9, wherein the trigger is located within a broadcast program.

11. The method according to claim 9 wherein the trigger has a temporal expiration.

12. The method according to claim 11 further comprising:
identifying the trigger within the selected broadcast program when an interactive content request signal is received from a user input device.

13. The method according to claim 12, wherein sending from the client device includes sending at least an indicia of the trigger to a processing office within the user request for interactive content.

14. A client device for receiving a broadcast program over a managed network and requesting and receiving interactive content over an unmanaged network, the client device comprising:
a managed network port for receiving broadcast program having one or more associated triggers;
a processor for creating a request for interactive content wherein the processor creates the request based upon a current trigger associated with the broadcast program;
an unmanaged network port for transmitting the request for interactive content to a processing office and for receiving the interactive content from the processing office.

15. A client device according to claim 14 further comprising: a user input receiver for receiving a user input signal indicative of selection of interactive content.

16. A client device according to claim 15 wherein the processor creates a request for interactive content when the user input receiver receives a user input signal from a user input device.

17. A client device according to claim 15 wherein in response to user input the processor sends a request for updated interactive content.

18. A client device according to claim 14 wherein the interactive content is not rendered on the client device.

19. A client device according to claim 14, further comprising:
a switching module for switching between the managed network port and the unmanaged network port in response to the user input signal.

20. A client device according to claim 14, wherein the processor decodes the interactive content before outputting the interactive content to a display device.

21. A client device according to claim 14 wherein the managed network port is a satellite network port and the processor decodes the broadcast program transmitted from a satellite in a first format.

22. A client device according to claim 21 wherein the processor decodes the interactive content encoded in a second format.

23. A client device according to claim 21 wherein the user input receiver is an infrared receiver for receiving a transmission from a user's remote control.

24. A computer program product having computer code on a computer readable storage medium operative with a processor for providing interactive content over an unmanaged network to a display device of a user, the computer code comprising:
computer code for receiving a broadcast content signal containing an interactive identifier over a managed network at a client device;
computer code for sending from the client device a request for interactive content based on the interactive identifier over the unmanaged network;
computer code for switching between receiving data from the managed network at the client device and receiving data from the unmanaged network;
computer code for receiving from the unmanaged network at the client device the requested interactive content; and
computer code for outputting the interactive content for display on the user's display device.

25. The computer program product according to claim 24, wherein the broadcast content signal contains a plurality of broadcast programs.

26. The computer program product according to claim 24 further comprising: computer code for selectively outputting one of the broadcast programs.

27. The computer program product according to claim 24 wherein the managed network is a satellite network.

28. The computer program product according to claim 24 wherein the managed network is an IP television network.

29. The computer program product according to claim 24 wherein the managed network is a cable television network.

30. The computer program product according to claim 24 wherein the interactive identifier has a temporal expiration.

31. The computer program product according to claim 24 further comprising:
computer code for identifying the interactive identifier within the selected broadcast program when an interactive content request signal is received from a user input device.

32. The computer program product according to claim 24 wherein the computer code for sending from the client device includes:
computer code for sending at least an indicia of the interactive identifier to a processing office within the user request for interactive content.

33. A method according to claim 1, wherein the client device comprises two separate enclosures where a first enclosure receives data from the managed network and a second enclosure that transmits and receives data from the unmanaged network.

34. A method according to claim 33 wherein switching requires a signal to be transmitted between the first enclosure and the second enclosure.

35. A method for providing modified video content to a display device associated with a client device that receives video content over a managed network, the method comprising:
receiving transmission of a video content signal at a location remote from a client device associated with a subscriber;
modifying the video content signal by stitching at least one other video signal together with the video content signal;
transmitting the modified video content signal on an unmanaged network to the client device coupled to the managed network;
wherein the modified video content signal includes a signal component indicating to the client device to switch between outputting the video program from the managed network and the modified video program on the unmanaged network.

36. The method according to claim 1, wherein the first encoded data stream having interactive content includes broadcast content.
